(19) United States
(12) Patent Application Publication
(10) Pub. No.: US 2007/0112921 A1
(43) Pub. Date: May 17, 2007

(54) Mapping electronic files contained in an electronic mail file to a file class

(76) Inventors: Tracy Theisen Lunt, Columbus, OH (US); David Paul Donohue, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/444,650

(22) Filed: Jun. 1, 2006

Related U.S. Application Data
(60) Provisional application No. 60/736,561, filed on Nov. 14, 2005.

(51) Int. Cl. G06F 15/16

(52) U.S. Cl. 709/206

(57) ABSTRACT

A computer-implemented method for identifying selected electronic files from a set of electronic files that contains at least one mail file includes the steps of: (i) using an operating agent and a mail server gateway, opening the mail file; (ii) for each of the plurality of electronic files in the opened mail file, creating a derivative attribute representative of the file class of that electronic file, the creation of each file class derivative attribute itself comprising the steps of: (a) determining the number of mail message markers in the file locator of that file; and (b) mapping that file to a file class if the file locator includes a predetermined number of mail message markers.

This application claims priority to U.S. Provisional Application No. 60/736,561, filed Nov. 14, 2005, the entire content of which is herein incorporated by reference.

### CROSS REFERENCE TO RELATED APPLICATIONS

Subject matter disclosed herein is disclosed and claimed in the following copending applications, all assigned to the assignee of the present invention:

Mapping An Electronic File To A File Class In Accordance With A Derivative Attribute Based Upon A Terminal File Extension And/Or MIME Type (CL-3103 USNA;

Identifying Electronic Files In Accordance With A Derivative Attribute Based Upon A Predetermined Relevance Criterion (CL-3063 USNA);

Using The Quantity Of Electronically Readable Text To Generate A Derivative Attribute For An Electronic File (CL-3105 USNA);

A Data Structure Generated In Accordance With A Method For Identifying Electronic Files Using Derivative Attributes Created From Native File Attributes (CL-3107 USNA); and

Mapping Parent/Child Electronic Files Contained In A Compound Electronic File To A File Class (CL-3334 USNA).

### FIELD OF THE INVENTION

The present invention relates to a computer-implemented method of identifying and mapping an electronic mail file to a file class, to a computer readable medium having instructions for controlling a computing system to perform the method, and to a computer readable medium containing a data structure used in the practice of the method.

### DESCRIPTION OF THE PRIOR ART

During the discovery phase of a lawsuit it is often necessary to gather large volumes of documents regarding the litigation. The documents need to be individually reviewed and, if found to be relevant to the issues of the case, delivered to opposing counsel. Counsel for all parties must agree on sets of key words that will cause a document to be considered relevant to the proceedings and, consequently, necessary to produce during the discovery process.

Increasingly, the documentation presented for review is created using any of a wide variety of software application programs. The electronic documentation is stored in a wide variety of storage media [floppy discs, hard drives, compact discs (CD's), digital video discs (DVD's)] and in a wide variety of formats. The documentation may be text, audio, visual or any combination.

All the documents, or electronic files, gathered in response to any discovery request must be read to discover key word content. Every electronic file must be accounted for in the process. A human being can process approximately two hundred such files a day. A typical litigation can easily include 150,000 to 250,000 files. The time to review this amount of documentation is on the order of eight thousand reviewer-hours (four reviewer-years !!). A large litigation can contain millions of electronic files that require review.

It is therefore apparent that an electronic processing solution is necessary to handle electronic files in a reliable, consistent manner. In order to avoid the extensive human component of document identification a computer-implemented operating agent program, often called an “indexing agent”, is employed.

A “batch”, which is a collection or set of electronic files, is presented to the operating agent. The operating agent opens each electronic file using specific document filters that allow the information within that electronic file to be “read” by the operating agent. Every character string found by the operating agent in the electronic file is entered into an index. The electronic files thus able to be read and indexed by the operating agent define a first subset of electronic files (all “indexable” files).

Many electronic files cannot be opened and read by the operating agent. For example, if no document filter exists for a particular type of electronic file, the operating agent is incapable of opening that file.

Similarly, an electronic file may be unreadable by the operating agent if it is encrypted, password protected, a compound file (such as a zipped file or an e-mail file), corrupted, written in another language or character set, or contains other anomalies.

All these remaining files define a second subset of electronic files (all “non-indexable” files). Information regarding the identity of each such electronic file is entered by the operating agent in a “log file” or another suitable document tracking construct such as a database. Each log file entry (or database entry) includes a notation regarding the problem(s) found with the electronic file.

It is not uncommon that upwards of thirty percent (30%) of the electronic files presented are unable to be opened by the operating agent. Human intervention is required to review all electronic files in the log file to insure that all files relevant to a litigation are included in a response to a discovery request.

Of course, the greater the number of electronic files requiring review by human interveners, the higher is the cost.

Even if the operating agent is able to open an electronic file the following issues need to be considered.

First, merely opening an electronic file is not always trustworthy or reliable in the sense that the information within the file is not necessarily processed. The operating agent may be unable to recognize and read the text in that file. For instance, if the text is in image format (e.g., scanned image in a pdf file) it may need to have human review.

Second, images could contain relevant material, but since their text content cannot always be read by the operating agent the image must be reviewed by a person.

Third, duplicates, dictionaries, and executable files are harvested and production of these files adds to the cost. If they are not recognized by the software during processing they will often be delivered and reviewed by a human unnecessarily.

Fourth, the file could contain confidential information or information protected by attorney-client privilege which may require additional review/handling.

A significant complication is introduced when compound files need to be considered. Typical examples of compound files are electronic mail files and “zip” files. These compound files contain one of more individual electronic files and/or one or more file groups. For example, an e-mail message with a document attachment is a file group. For many reasons the electronic files in the file group must be kept together. For instance, during litigation document discovery it is often important to track who sent and who received a specific electronic file, as well as when this occurred.

In view of the foregoing it is believed advantageous to provide a computer-implemented electronic file identification method that is cheaper, easier, more trustworthy and more accurate. For instance, given that a set of electronic files to be reviewed contains a potentially large fraction of electronic files that are not readable by the indexing agent, it would be valuable if the operating agent were capable of making reliable decisions regarding these files where possible. Since all non-indexable files contain at least one or more readable native attribute(s), there exists the opportunity for the operating agent to make some determinations using those native attribute(s).

It is believed to be of further advantage that file groups can be tracked together.

### SUMMARY OF THE INVENTION

The present invention relates to a computer-implemented method, program and data structure for identifying selected electronic files contained within a set of electronic files. The set of electronic files may include at least one mail file. An electronic files is selected based upon one or more derivative attribute(s). Each derivative attribute is created from one or more identified native attribute(s) inherent in each electronic file. The derivative attributes, whether taken alone or considered combinatorily, serve as a basis for deciding various recommended actions regarding the electronic files.

As preliminary steps an operating agent is utilized to subdivide a collection, or set, of electronic files into a first subset and a second subset. The first subset contains each electronic file that is able to be opened by the operating agent. The second subset contains each electronic file in the remainder of the collection of electronic files that is not able to be opened by the indexing agent.

For each electronic file in the first subset the operating agent identifies at least one native attribute, such as the MIME type of the electronic file or the file locator of the file. The file locator may itself be considered to include one or more native attributes of the file, such as a file extension.

In one aspect the present invention is directed to a computer-implemented method for identifying selected electronic files from a set of electronic files that contains at least one mail file. The mail file itself includes a plurality of electronic files. Each electronic file in the mail file includes a document locator having one or more mail message markers therein.

The method includes the steps of:
(i) using an operating agent and a mail server gateway, opening the mail file;
(ii) for each of the plurality of electronic files in the opened mail file,
creating a derivative attribute having a value representative of the file class of that electronic file,
the creation of each file class derivative attribute itself comprising the steps of:
   (a) determining the number of mail message markers in the file locator of that file; and
   (b) mapping that file to a file class if the file locator includes a predetermined number of mail message markers.

For each electronic file whose file locator does not include the predetermined number of mail message markers (or if the set of electronic files does not contain a mail file), a derivative attribute having a value that is representative of the file class for the electronic file is created. The value of this file class derivative attribute indicates the software application used to create the electronic file and/or the type of software application intended to open the electronic file. If a native attribute identified by the operating agent for each electronic file in the first and second subsets is a terminal file extension for that electronic file (without MIME type) the file class derivative attribute is created by mapping that file extension to a file class. If the MIME type of a file is also one of the native attributes identified by the operating agent the file class derivative attribute is created using a combination of the identified terminal file extension and the MIME type to map the file to a file class. The mapping is determined by the MIME type so long as the MIME type falls within a predetermined set of approved MIME types; otherwise, the mapping is determined by the terminal file extension.

In another aspect the present invention is directed to a computer-implemented method for identifying electronic files from a set of electronic files that contains at least one compound file, the compound file itself including a plurality of electronic files,

the method including the steps of:
(i) using an operating agent and a gateway, opening the compound file; and
(ii) from the plurality of electronic files in the opened compound file,
   identifying a subset of parent electronic files, wherein each parent electronic file includes one or more file pointer native attributes;
   identifying each child file corresponding to each file pointer native attribute in each parent electronic file; and
for each file group comprising a parent file and each child file corresponding thereto, classifying the group into one of the predetermined plurality of recommended actions based upon the highest ordered recommended actions in the group.

In other embodiments the present invention is directed to a computer readable medium having instructions for controlling a computing system to perform any of the aspects of the method above discussed, and to a computer readable medium containing a data structure created during the implementation of the various aspects of the method of the present invention.

### BRIEF DESCRIPTION OF THE DRAWINGS

The present invention will be more fully understood from the following detailed description, taken in connection with the accompanying drawings, which form a part of this application and in which:

FIG. 1 is a stylized diagrammatic view of a computer-implemented electronic file identification method utilizing an operating agent program of the prior art interfaced with a program embodying the teachings of the present invention;

FIG. 2A is a stylized illustration of a typical electronic document or non-document file, while FIG. 2B is a stylized illustration of a typical electronic mail file;

FIG. 3A is a definitional diagram indicating the various components of a file locator for a typical electronic file, while FIG. 3B is a definitional diagram indicating the various components of a file locator for a typical e-mail message;

FIGS. 4A through 40 are stylized illustrations of various electronic files used to explain and to exemplify the operation of the present invention;

FIG. 5 is an illustration of a portion of a log file produced by an operating agent of the prior art;

FIGS. 6A and 6B are an overall flow diagram of the method of the present invention;

FIG. 7 is a flow diagram of the determination of various derivative attributes and the populating of a data structure in accordance with the method of the present invention;

FIG. 8 is a diagrammatic representation of a data structure created during the operation of the method of the present invention; and

FIGS. 9A and 9B are a flow diagram of the routing logic that utilizes derivative attributes to assign identified electronic files to various recommended actions.

### DETAILED DESCRIPTION OF THE INVENTION

Throughout the following detailed description similar reference numerals refer to similar elements in all figures of the drawings.

It should be understood that although the following description is framed in the context of the identification and selection of electronic files in connection with the discovery phase of a litigation, the various embodiments of the present invention may be applied to any of a wide range of knowledge mining operations that include document identification and selection tasks where proper handling and tracking of every document is important. Investigations involving antitrust issues, government inquiries, and Sarbanes-Oxley audits serve as typical examples.

As used herein, the term “electronic file” or “electronic files” is construed to include any electronically stored information, including, but not limited to, electronic document file(s), electronic non-document file(s) (e.g., image, audio or other files) and electronic mail files. An electronic mail file is itself comprised of one or more electronic mail messages [herein “e-mail message(s)”]. An electronic mail file may also include electronic document file(s) and electronic non-document file(s).

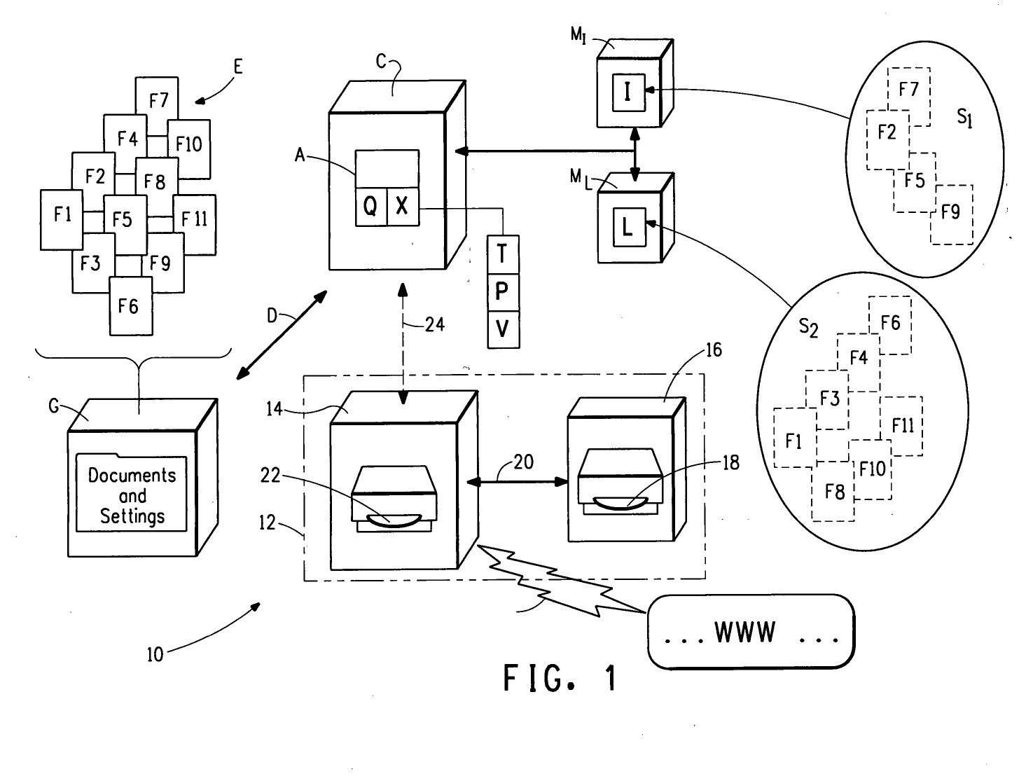

FIG. 1 includes a stylized diagrammatic view of a computer-implemented electronic file identification method of the prior art that utilizes an operating agent program A. Those elements contained within a typical prior art implementation are indicated in the Figures by alphabetic reference characters.

The present invention, indicated generically by the reference character 10, is directed in one embodiment to a method that is implemented by a computing system generally indicated by the reference character 12. The computing system 12 includes a processing unit (“processor”) 14 and an associated data repository 16. The data repository 16 stores a data structure 18 produced during the implementation of the method of the present invention on a suitable computer readable medium. The processing unit 14 writes to and reads from the data repository 16 over a bus 20. A computer readable medium read by the processing unit 14 contains a program 22 of instructions for controlling the computing system 12 to perform the method in accordance with the present invention 10. The data structure 18 and the program 22 define other embodiments of the present invention 10.

The computing system 12 may be configured using any suitable computer, such as a desktop computer or an application server having a Microsoft Windows® operating system. The data repository 16 may be implemented using any data storage arrangement controlled by a suitable database management system, such as Oracle Database® database software available from Oracle® Corporation, or as MySQL® database software available from MySQL® AB.

In the preferred implementation of the present invention 10 certain functional modules within the operating agent A are called upon for use by the processor 14. Accordingly the processor 14 must be able to interface and to interoperate with operating agent A. To this end a functional connection diagrammatically by reference character 24 extends between the computing system 12 implementing the method of the present invention and the operating agent A. Of course, it also lies within the contemplation of the present invention that such functions may be performed without direct reliance upon the operating agent A. An internet connection, diagrammatically indicated by reference character 28, that facilitates web-based access and delivery of results is also desirable.

The present invention in its method, program and data structure embodiments is useful to identify electronic files of particular interest from a collection of native format electronic files. The electronic files so identified using the present invention are selected for suitable handling and disposition.

The overall collection of native format electronic files is generally indicated by reference character E. For purposes of the discussion herein the collection E contains a set of electronic files indicated diagrammatically by the reference characters F₁ through F₁₅.

In a typical instance the electronic files F₁ through F₁₅ are gathered from a variety of custodians and locations and are presented in a variety of storage media. For convenience of accessibility the electronic document and non-document files F₁ through F₁₁ and F₁₅ in the collection E are stored in a suitable document repository, such as a document server G. The collection E includes a mail file stored in a suitable message repository, such as an e-mail server H. In FIG. 1 the mail file is shown to contain e-mail messages F₁₂ through F₁₄. The e-mail messages F₁₃ and F₁₄ have respective electronic document files F′₅ and F′₁ as attachments. The treatment of such e-mail messages is discussed in full detail herein.

The e-mail messages F₁₃ and F₁₄ and the electronic non-document file F₁₅ are also compound file groups, in that each comprises a parent file having one or more child files attached thereto. The treatment of such compound file groups is also discussed in full detail herein.

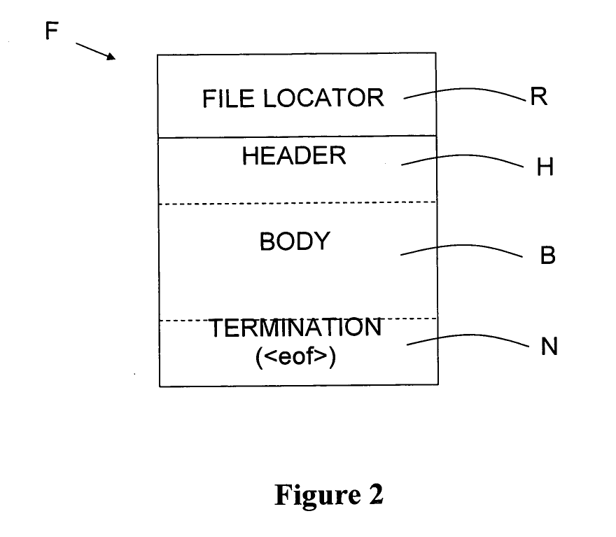

A stylized illustration of a typical electronic document file or electronic non-document file F is illustrated in FIG. 2A. A stylized illustration of a typical electronic mail file is shown in FIG. 2B.

As seen from FIG. 2A, in general, each electronic document file or electronic non-document file in the collection includes a file locator R, a header H, a body B, and a termination N. All of these file aspects are generated by the application software used to create the file.

A typical electronic mail file, shown in FIG. 2B, can be comprised of a number “n” of e-mail message(s), identified in FIG. 2B as File Constituents_{1, 2, . . . n}. Each of these e-mail messages could contain electronic document file(s) and/or electronic non-document file(s) as attachments.

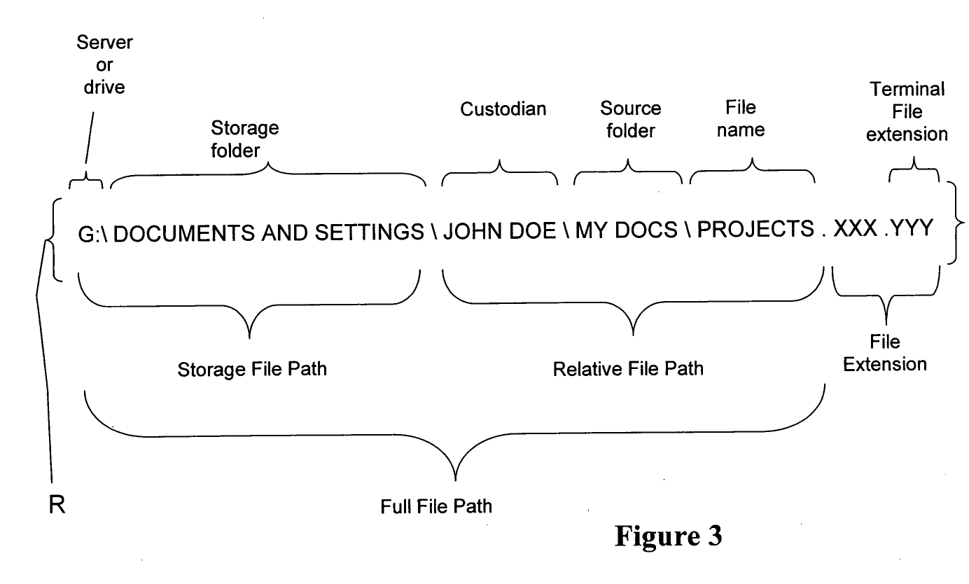

Each of these File Constituents includes similar file aspects as an electronic document file and an electronic non-document file (FIG. 2A). The file locator R specifies the file path within the repository G or H by which each electronic file in the collection E may be accessed. The syntax of a file locator R for a typical electronic document file or an electronic non-document file F is indicated in FIG. 3A, while the syntax of a typical file locator R for a typical e-mail message (or attachment) is shown in FIG. 3B. The full extent of the file locator R is contained within the braces “{ }”.

Other forms of compound files, such as a “.zip” file exhibit the same file aspects as the mail file represented in FIG. 2B. In such a case the File Constituents are comprised of electronic document file(s) and/or electronic non-document file(s).

As shown in FIG. 3A, in the case of an electronic document file or electronic non-document file, the file locator R comprises a full file path and one or more file extension(s). The full file path includes both a storage file path and a relative file path. The storage file path specifies the identity of the system and location hierarchy where the electronic document file or electronic non-document file currently resides. In the context of the specific example shown in FIG. 3A the storage file path is “G:\Documents and Settings”. This indicates that the electronic document file or electronic non-document file is stored on the “G” server, in the folder “Documents and Settings”. Additional folders in the folder hierarchy (if present) would also be specified.

The relative file path sets forth the custodian of the file, the hierarchy of folder(s) containing the electronic document file or electronic non-document file, and the file name. In the context of the example shown in FIG. 3A the relative file path is “John Doe\My Docs\Projects”. The custodian of the electronic document file or electronic non-document file is “John Doe”. The file named “Projects” is stored in the folder “My Docs”.

Generally speaking, one or more file extensions of any arbitrary length, as created by the author or as applied by the software application used to create the electronic document file or electronic non-document file, may be included in the file locator R. As a typical example (not shown) the well-known file extension “.doc” appended to the end of a document indicates that the electronic document file is created using the Microsoft Word® word processor program available from Microsoft Corporation.

An electronic document file or electronic non-document file may contain more than one file extension. In the example in FIG. 3A a cascade of hypothetical file extensions “.xxx.yyy” follows the file name. The file extension following the last-appearing period in the file locator (in the example of FIG. 3A, “yyy”) is herein termed the “terminal” file extension.

It should be noted that some creating application programs do not insert a default file extension or require an author to insert a file extension. Moreover, an extension that is appended to a file name or required by the creating application may nevertheless be deleted or altered by the author. In these situations where the extension is omitted or deleted it is considered to be a “null” extension (herein indicted as “[NULL]”). Because of the possibility of omission, deletion or alteration, basing a decision as to file identification upon a file's extension is believed not a totally reliable practice.

As shown in FIG. 3B, in the case of an e-mail message, the file locator R comprises a full file path and message and attachment information.

The full file path again includes both a storage file path and a relative file path. The storage file path specifies the identity of the system and location hierarchy where the e-mail message currently resides. In the context of the specific example shown in FIG. 3B the storage file path is “H:\Litigation E-Mail”. This indicates that the e-mail message is stored on the “H” server, in the folder “Litigation E-Mail”. Additional folders in the folder hierarchy (if present) would also be specified.

The relative file path sets forth the custodian of the file, the hierarchy of folder(s) (if any) containing the e-mail message, and the mail file name. In the context of the example shown in FIG. 3B the relative file path is “John Doe\doej2”. The custodian of the e-mail message is “John Doe”. The name of the mail file in which this particular message is “doej2”. As is typical for an e-mail message, there is no further hierarchy in the relative file path. It should be noted that other messages sent by or received by this custodian could potentially also be stored in this mail file.

The mail file extension typically identifies the program used to generate the mail file. For instance, the Lotus® Notes® mail program available from IBM Corporation uses the standard mail file extension “.nsf”. Mail files created using the Microsoft Outlook® mail program available from Microsoft Corporation use the standard mail file extension “.pst”.

A mail message marker is typically used in mail message identification in a fashion similar to the use of the “\” used to distinguished folders on servers. In FIG. 3B the mail message marker takes the form of one or more characters “!!”.

The message and attachment information portion of the file locator R includes detailed identification information on both the e-mail message and any possible attachment(s).

The mail message identifier is often constructed of a unique string of numbers and letters (in the instance illustrated, a sequence of hexadecimal characters) used to identify uniquely a mail message in the mail file.

In the instance where an e-mail message contains an attachment, attachment information is also available in the file locator R to identify uniquely the attachment in the mail file. In FIG. 3B the attachment information includes the Attachment Identifier which gives the Attachment File Name and the Attachment File Extension(s). The same considerations for file extensions as discussed in connection with FIG. 3A are applicable in the case of the file locator R shown in FIG. 3B.

With reference again to FIG. 2A or 2B the header H of an electronic file is a character string containing information about the file, such as the file title, the file size, the identity of the author, the date and time that the file was created or last modified, file pointers and privacy flags.

The header H may also have embedded therein information regarding the identity of the software used to create the file. This information string is also sometimes referred to as the MIME-content type (“MIME type”) of the file.

“MIME” is an acronym for Multipart Internet Mail Extension. The general categories of MIME types assigned and listed by the Internet Assigned Numbers Authority (“IANA”) include: application, audio, image, message, model, multipart, text, video. Each general category contains numerous subcategories.

Although it is believed to be a better practice, not all files include a MIME type in the header. Under some operating systems the MIME type, if inserted by the creating application, can be changed by the author. Moreover, even if present and not altered, the MIME type can be misread. Accordingly, since the MIME type may be omitted, altered, or misread, it is also believed not a totally trustworthy indicator upon which to base file identification.

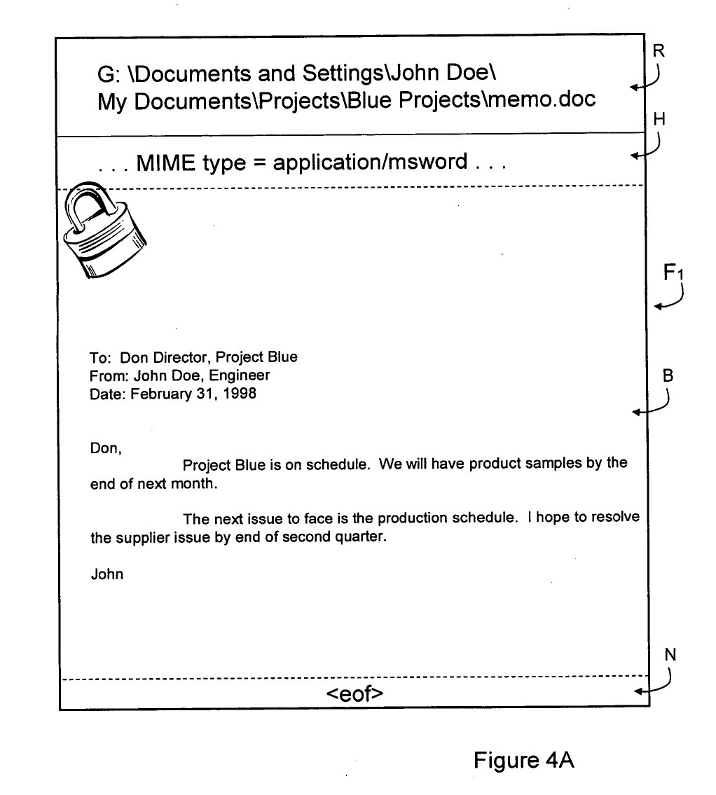

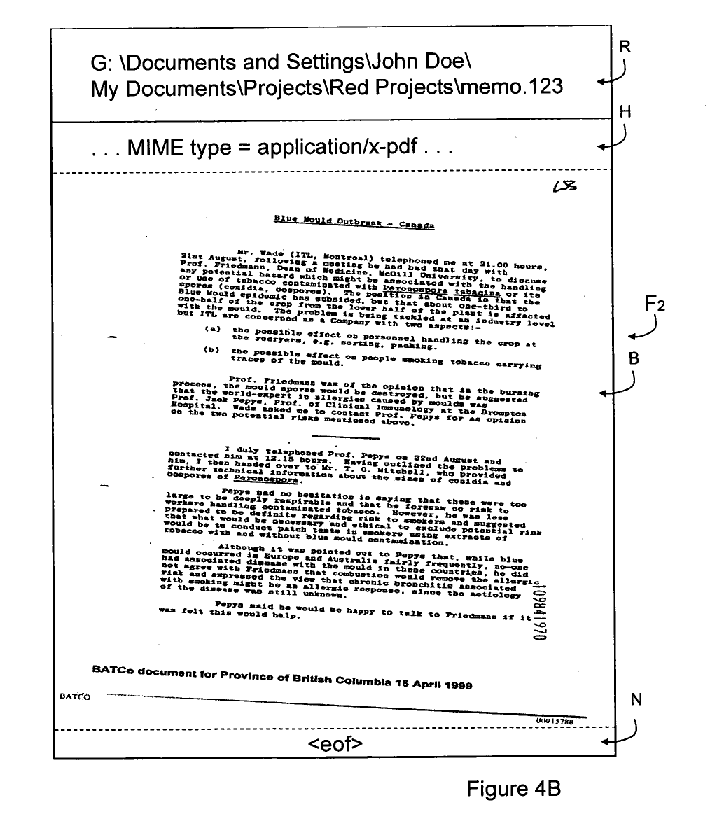

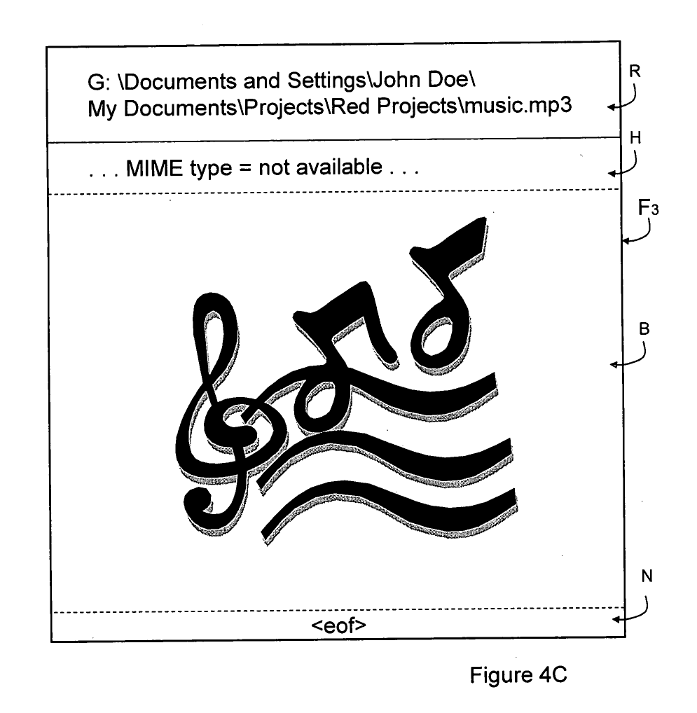

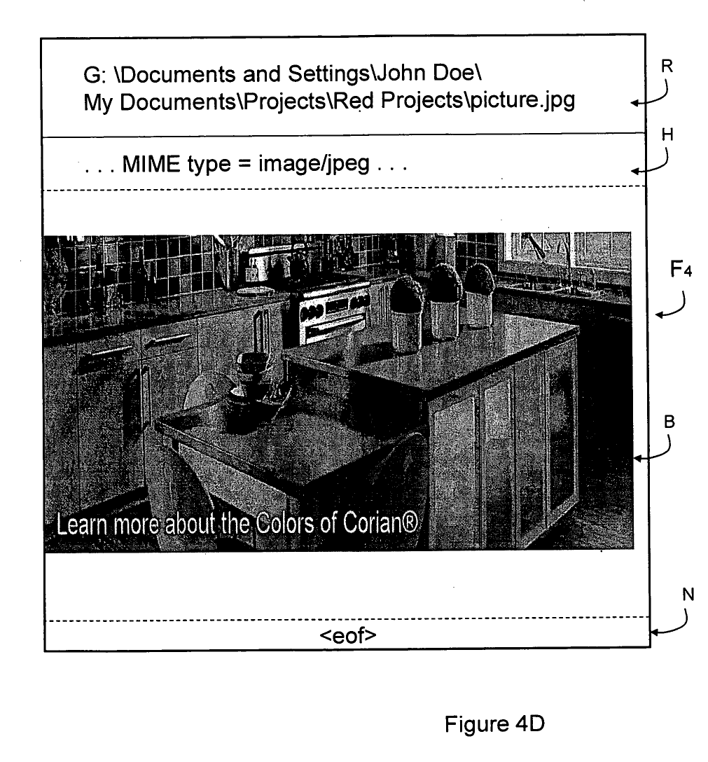

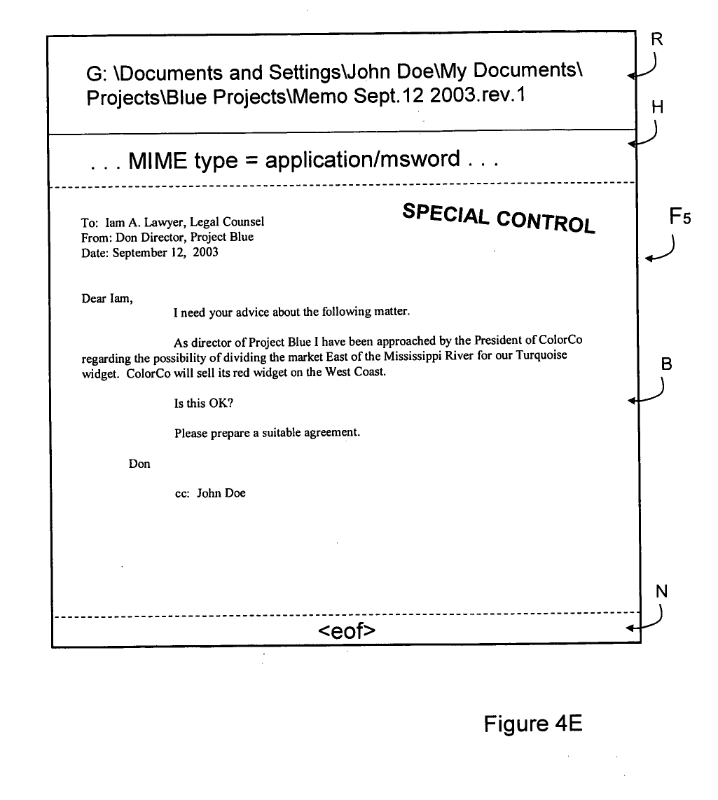

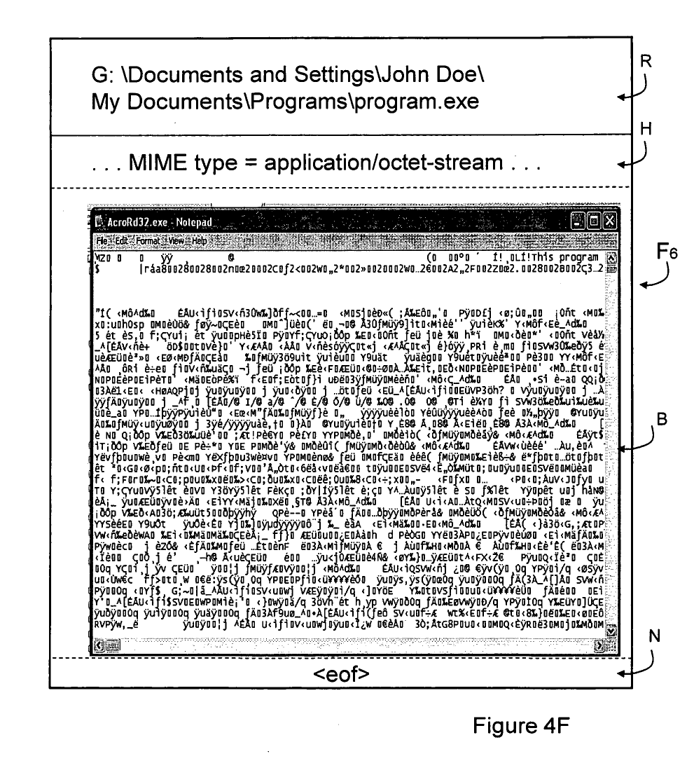

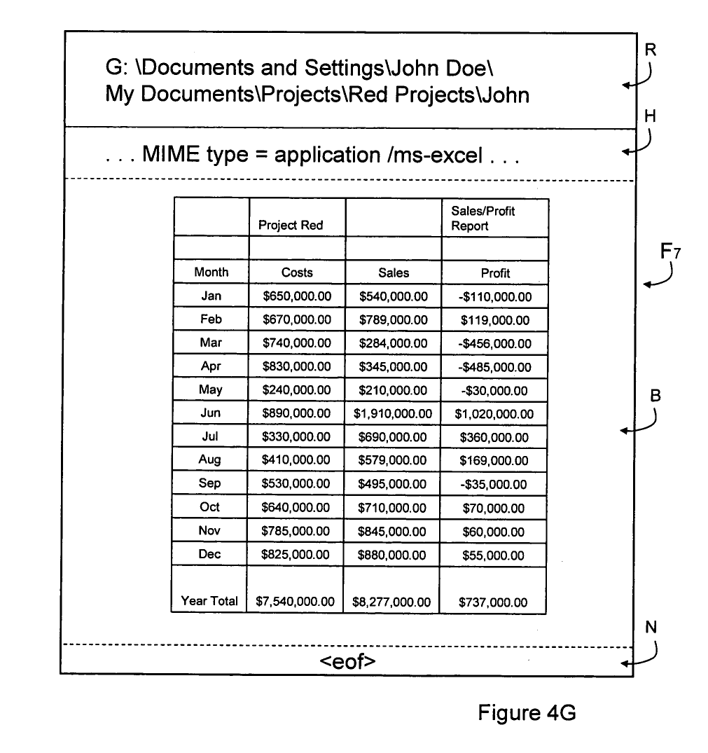

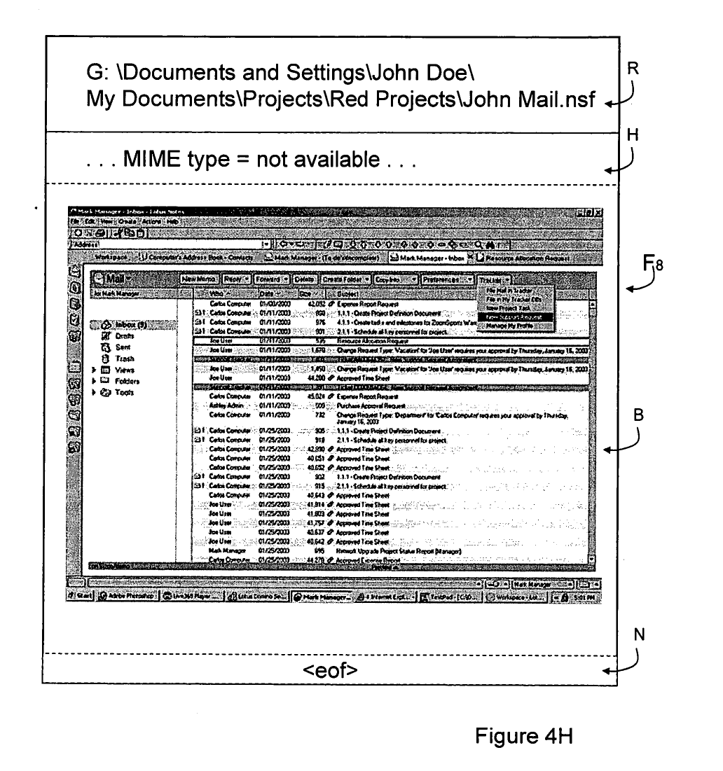

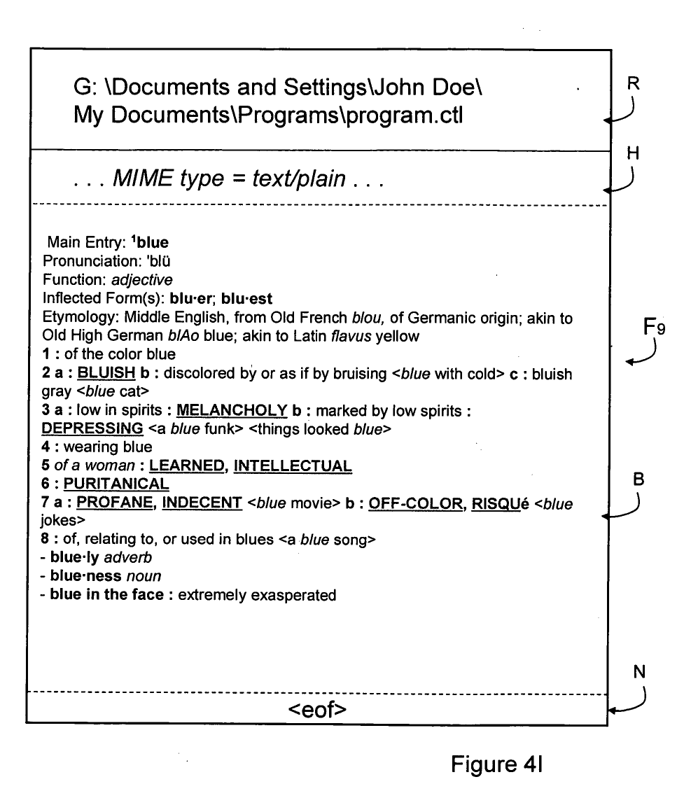

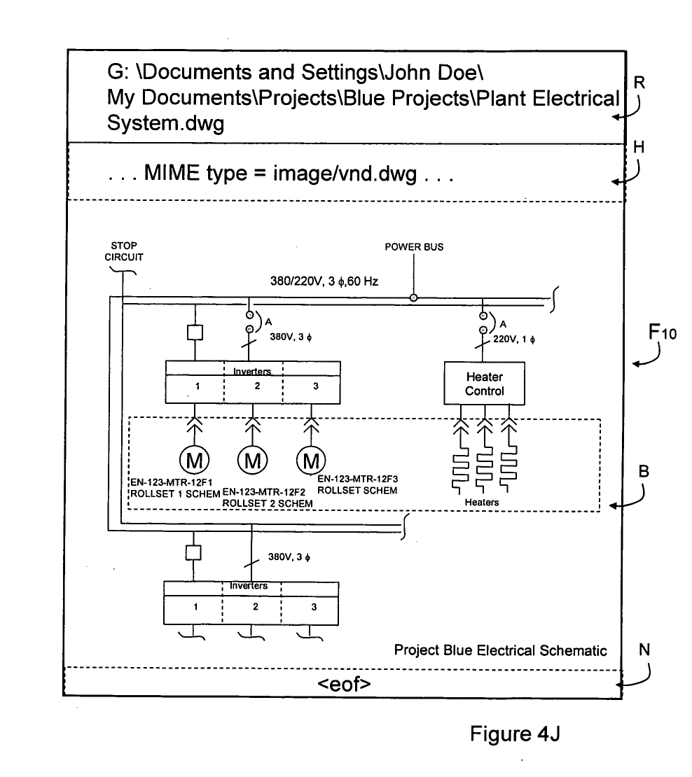

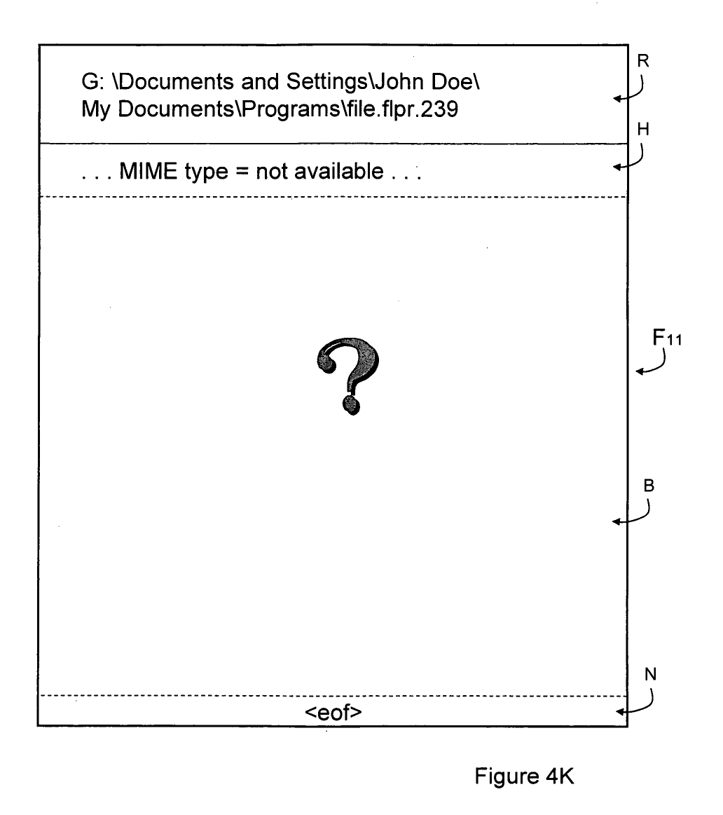

The communicative content contained within the electronic file (as opposed to information about the electronic file contained in the file locator and header) is carried in the file body. As will be developed in connection with the various sample electronic files illustrated among FIGS. 4A through 40, the file body B may include one or more computer-readable character strings, non-readable locked or encrypted text, or non-readable image or audio/visual data.

The file termination N contains at least an end-of-file marker. This marker is typically denoted by the symbol “<eof>”. In the case of a compound file the internal separation between messages (e.g., e-mail messages) is a message terminator denoted by the symbol “<eom>”.

Native Attributes For the purposes of the present invention all of the parameters intrinsically found within an electronic file are collectively termed the “native attributes” of the electronic file.

For the purposes of this discussion of the present invention, the file locator R itself, as well as the various elements contained therein [such as the file name, the file paths, and the file extension(s)], the various pieces of information listed earlier about the file contained within the header H [e.g., the MIME type, privacy flag, pointer(s)], and the character strings that comprise the communicative content carried in the body, are each to be considered among the native attributes of an electronic file. Native attributes further include the date of the electronic file, the title and the author. For purposes of the present invention the gateway type used to open the file and the subset S₁ or subset S₂ in which the electronic file resides may also be considered as native attributes even though they are generated by the operating agent A.

For purposes of an example of the function and operation of the various aspects of the present invention that is to be developed throughout the discussion in this specification, the collection E is assumed to include the following electronic files F₁ through F₁₅ (each of which is illustrated in the respective stylized representations shown in FIGS. 4A through 40).

A stylized depiction of the electronic file F₁ is shown in FIG. 4A. This electronic file is a memorandum created using Microsoft Word® word processor program. The header H of this file indicates the MIME type as “application/msword”. The file is password locked, as represented by the padlock symbol, rendering it immune from being opened by the operating agent A.

FIG. 4B is a stylized depiction of the electronic file F₂. The body of this electronic file contains a scanned document created using the Adobe Acrobat® electronic document distribution and exchange creation program available from Adobe Systems Incorporated. The MIME type contained in the header H of this file indicates the MIME type as “application/x-pdf”.

FIG. 4C depicts an audio/visual file F₃. No MIME type is available in the header H.

Electronic file F₄, depicted in FIG. 4D, is an example of an image file. The MIME type available from the header H of this document is “image/jpeg”.

FIG. 4E illustrates electronic file F₅. This electronic file F₅ is a hypothetical, fanciful memorandum created using Microsoft Word® word processor program. The header H of this file includes the MIME type “application/msword”. The body of this file includes computer-readable text.

FIG. 4F is a representation of an executable program file F₆. The MIME type indicated in the header is “application/octet-stream”.

Electronic file F₇, illustrated in FIG. 4G, contains readable text in spreadsheet form. The file is created using Microsoft Excel® spreadsheet program available from Microsoft Corporation. The typical file extension (“.xls”) for such a file has been deleted by the author. Thus, the file is considered to have a [NULL] extension. The header H of this file includes the MIME type “application/ms-excel”.

FIG. 4H is a compound file in the form of a mail file F₈. A compound file is itself an amalgamation of a plurality of individual records or messages. No MIME type is available for this compound file. This mail file is treated as a single undecipherable file. In this instance the individual messages contained in the mail file are not distinguishable as separate e-mail messages.

FIG. 4I is a rendering of an electronic dictionary file F₉. Such a file is usually lengthy and almost invariably contains one or more key words of interest. No MIME type is usually available in the header H for such a file. However, as will be discussed, it is possible that the operating agent A could assign a “text”-class MIME type to the file. Accordingly, in FIG. 4I the MIME type “text/plain” is indicated in italics in the header H.

FIG. 4J is a stylized depiction of an electronic drawing file F₁₀ created using a computer-aided drafting program. The MIME type available in the header H is “image/vnd.dwg”.

Electronic file F₁₁ shown in FIG. 4K is meant to represent a file of an unknown type that is not previously encountered and is, therefore, unable to be handled.

FIGS. 4L through 4N depict individual e-mail messages F₁₂ through F₁₄. As indicated in the file locator section R, each of these individual e-mail messages is contained in the same mail file (“doej2.nsf”) stored on the mail server H. For a reason similar to that discussed in connection with FIG. 4I the MIME type for each of these e-mail messages is “text/plain” and is indicated in italics in each header H.

The individual e-mail message F₁₂ (shown in FIG. 4L) has an asserted (“ON”) privacy flag native attribute in its header H. The presence of an asserted privacy flag renders the text in body B of this individual e-mail messages unreadable by the operating agent A. This is represented by the padlock symbol.

FIGS. 4M and 4N show respective individual e-mail messages F₁₃ and F₁₄ that have an unasserted (“OFF”) privacy flag native attribute in their header H, rendering the text in their body B readable by the operating agent A. Each of these individual e-mail messages has an attachment, thus requiring the presence of a file pointer native attribute in the header H. The file pointer native attribute indicates the storage location of the attachment. The attachment is also indicated graphically by the icon in the body B.

In the case of individual e-mail message F₁₃ the attachment is an exact copy of all of the native attributes and full text of the original electronic file F₅. However, since this attachment is a copy that is stored in a different location than the original electronic file F₅ (mail server H as part of the “doej2.nsf” mail file), it has a different file locator and is represented by the different reference character F′₅. The file pointer for the attachment F′₅ includes the full file path, the mail file extension and the message identifier of its parent (i.e., the individual e-mail message F₁₃). It also includes as the attachment identifier the file name and file extensions of the original electronic file F₅.

The attachment to individual e-mail message F₁₄ is an exact copy of all of the native attributes and full text of the original electronic file F₁. Similarly, since this attachment is a copy is also stored in a different location than the original electronic file F₁, it also has a different file locator and is represented by the different reference character F′₁. The file pointer for the attachment F′₁ includes the full file path, the mail file extension and the message identifier of its parent (i.e., the individual e-mail message F₁₄) and also includes as its attachment identifier the file name and file extensions of the original electronic file F₁.

FIG. 40 is a stylized depiction of compressed compound electronic file F₁₅. The header H of this file indicates its MIME type as “application/zip”.

The body of this file electronic file F₁₅ contains an exact copy of all of the native attributes and full text of three original electronic files F₂, F₅ and F₇. These copies are represented in FIG. 40 by the respective reference characters F′₂, F″₅, and F′₇. The copy of original electronic file F₅ in this file is denoted by the reference character F″₅ because it is different both the original electronic file F₅ and the copy F′₅ attached to the e-mail message F₁₃. The file pointer native attribute indicating the storage location of these copies are found in the header H of the electronic file F₁₅.

It should be noted that, as shown in FIG. 1, the attachments and/or copies F′₁, F′₂, F′₅, F″₅, and F′₇ are included as individual electronic files in the overall collection of native format electronic files E.

Prior art computer-implemented electronic file identification methods for identifying and selecting electronic files from the collection E of electronic files utilize the operating agent program A. The operating agent program A resides on a suitable host computer C and communicates over a bus D with the servers G and H in which the collection E is stored. An operating agent program preferably utilized with the present invention is the program Verity K2 Enterprise available from Verity Incorporated, Sunnyvale, Calif.

In accordance with one aspect of the invention the operating agent A serves to subdivide the collection E of electronic files into two subsets. The first subset S₁ of electronic files includes those files able to be opened by (i.e., accessible to) and indexable by the operating agent A. The second subset S₂ contains all other electronic files in the remainder of the set of electronic files.

Using one or more internal gateways and a library of available document filters the operating agent program A attempts to open each of the electronic files F₁ through F₁₅ (including the attachments and/or copies F′₁, F′₂, F′₅, F″₅, and F′₇) in the collection E presented to it. For each electronic file that it is successfully able to open the operating agent includes a functionality able to create an index I, or organized list, containing every accessible character string used in the electronic file. The index I is stored in a memory M_{I}. The index I is organized in a predetermined manner, typically in alphabetic order. Since the files physically remain in the servers G and H, FIG. 1 depicts the files grouped into the first subset S₁ in outline form, indicating that only information about and information from the files is stored in memory M_{I}.

The gateway is the module of the operating agent A that enables the agent A to open the document repository (server G or H, as the case may be) to access the individual electronic files. For instance, a suitable gateway enabling the operating agent A to open the document server G is a Windows® Document gateway. This gateway is indicated by the reference character W₁. Other suitable document server gateways include a Unix document gateway or an HTTP document gateway. A suitable gateway enabling the operating agent A to open the mail server H is a Lotus® Notes® gateway. Other suitable mail server gateways include Microsoft Exchange gateway and ODBC gateway. This gateway is indicated by the reference character W₂.

The result of the use of an inappropriate gateway is able to be understood by a comparison of the mail file F₈ “John Mail.nsf” stored on server G (FIG. 4H) with the individual e-mail messages F₁₂ through F₁₄ (FIGS. 4L through 4N) contained in the electronic mail file “doej2.nsf” stored on server H. Since the file F₈ is read by the Windows® Document gateway it is treated as a single indivisible compound file in which individual e-mail messages are not distinguishable. Conversely, the use of a Lotus® Notes® gateway on the mail file “doej2.nsf” results in the three separate e-mail messages shown in FIGS. 4L through 4N.

The operating agent A also identifies one or more of the various native attributes contained in the electronic files it is able to open, such as the file locator R and the MIME type. For purposes of the example being developed, it is assumed that the operating agent A contains a set of filters for documents created by (1) Adobe Acrobat® electronic document distribution and exchange creation program [F₂, FIG. 4B]; (2) Microsoft Word® word processor program [F₅, FIG. 4E]; (3) Microsoft Excel® spreadsheet [F₇, FIG. 4G]; as well as a generic filter [F₉, FIG. 4I]. Thus, electronic files F₂, F₅, F₇, F₉, F₁₂, F₁₃, F₁₄, and F₁₅ would be opened using the operating agent A. Note that, in all cases to be discussed, a copy of any electronic file (such as the electronic files F′₂, F′₅, F″₅ and F′₇) would be receive the same treatment as its counterpart original. That is, these copies would be able to be opened by the operating and would be included in the subset S₁.

The operating agent A identifies and stores the electronic files it is able to open (i.e., for the files in the first subset S₁) the file locator native attribute R in toto, as well as the individual native attributes included therewithin: file name; full file path; relative file path; custodian; mail file name, and attachment identifier. The operating agent A also attempts to identify and store various pieces of header information, including the native attribute MIME type. The operating agent also may identify additional native attributes present in the electronic file, such as file date (i.e., date the file is last modified), file title, author, file pointer(s), privacy flag and file size.

Since the files F₅, F₇, F₉, F₁₃ and F₁₄ contain computer-readable text the operating agent A is able to create an index entry for each character string (each string of alpha-numeric characters separated by a space or a punctuation mark) in the body B of these files. For purposes of the discussion of this invention these character strings are considered native attributes of the particular file.

The treatment accorded to the file F₂ (FIG. 4B) by the operating agent A merits attention. Even though, as seen from the representation shown in FIG. 4B, the body of this file is intelligible to humans, the content of this file is a scanned image, not computer-readable text. So although the operating agent A is able to open this file, to the operating agent A this file does not contain any readable character strings.

The electronic file F₁₂ has its privacy flag asserted. The operating agent A is not allowed access to the full text body B of that electronic file. Therefore the only readable character strings are derived from the header H. The electronic file F₁₅ itself does not contain any readable character strings in its body. Instead, the body B contains exact copies of three original electronic files. The readable character strings for each of these three copies are indexed in the same manner as the corresponding originals.

The assignment of MIME type by the operating agent also merits some discussion. In general, the operating agent relies upon the file header H to identify the MIME type of the file. For the files F₂, F₅ and F₇, which are opened using the respective filters for Adobe Acrobat® electronic document distribution and exchange creation program [F₂], Microsoft Word® word processor program [F₅] and Microsoft Excel® spreadsheet program, these files are assigned MIME types corresponding to these applications, viz., “application/x-pdf” [F₂], “application/msword” [F₅], and “application/ms-excel” [F₇], respectively.

The files F₉, F₁₂, F₁₃ and F₁₄ are opened using the generic filter. Although these files do not contain a MIME type embedded within their header, since the files does contain readable text in some portion of the file, it is likely that the operating agent A would assign its default MIME type, e.g., “text/plain”, to these files. The default MIME type is indicated in italic text in FIGS. 4I, 4L, 4M and 4N. The assignment of such a default MIME type to a file would not provide a clear indication as to the application program used to create this file. As such the use of the default MIME type is misleading.

The prior art operating agent A also typically includes a search function operator Q that imparts the capability to the operating agent A to make a determination of the relevance of each file that it is able to open to particular issues. The determination is based upon a comparison of the character strings in each native attribute of each file against a set of target character strings (key words) contained in one or more target character lists.

In the context of file identification for purposes of a litigation a relevance target character list T, a privilege target character list P and a confidentiality target character list V are usually defined. The relevance target character list T contains a set of target character strings that, if found in a given file, would indicate that the file is relevant to issue(s) in the litigation. Similarly, the privilege target character list P contains a set of target character strings that, if found in a given file, would indicate that the file contains information to which a privilege is attached. The confidential target character list V contains a set of target character strings that, if found in a given file, would indicate that the file contains information contains personal or confidential material.

The various target characters strings for the different topics may be applied hierarchically (in which a determination of privilege or confidentiality would occur only if relevance is satisfied) or as independent inquiries.

By way of example, if it is assumed that the subject matter of a litigation involves an issue around the a bio-scientific development project for a blue-green mold referred to by the codename “Project Blue”, the relevance target character list T would likely include the key words “blue”, “green”, “turquoise”, and some number of additional synonymous words.

A well-devised relevance target character list would also include a context filter X. This is a logical device whereby the operating agent is able to distinguish the relevance of a document containing a key word term by the context in which the key word appears. For example, in connection with a litigation involving “Project Blue” a file that contains only a message to the effect that the author feels “blue” on a particular day is unlikely to be identified as relevant. Thus, the context filter might be configured to exclude and ignore cases in which the operating agent finds terms like “feeling” and “mood” near the term “blue” where it has a different kind of meaning within the context of that document.

The privilege target character list P would likely include as key words the names of counsel, and the terms “Legal” and “opinion”, for example. Key words for a confidential target character list V would likely include the term “confidential”, “secret”, “special control”, and terms relating to health or financial condition (e.g., social security and/or credit card numbers).

Applying the various target character lists to the electronic files F₂, F₅, F₇, F₉, F₁₂, F₁₃, F₁₄, and F₁₅ the operating agent A would likely identify the document F₉ as relevant and identified for production to opposing counsel. The document F₅ would be identified as relevant but privileged. The documents F₂, F₇, F₁₂, F₁₃, F₁₄, and F₁₅ would be identified as not relevant because, to the operating agent, these files do not contain any character string matching a key word in the relevance target character list.

For convenience, some of the native attributes for the electronic files in the first subset S₁ as identified by the operating agent A during the creation of the index I, together with the results of the comparison against the target characters set T, P and V are summarized in the following Table 1.

TABLE 1
Native Attributes (Subset S₁)

| | | | | | | Relevant/ |
|---|---|---|---|---|---|---|
| | | Extension | | Privacy | File | Privileged/ |
| File | Full File Path | (s) | MIME Type | Flag | Pointer | Confidential |
| F₂ | G:\Documents and Settings\ | .123 | Application/ | N/A | N/A | Not |
| | John Doe\MyDocuments\Projects\ | | x-pdf | | | Relevant |
| | Red Projects\Memo.123 | | | | | |
| F′₂ | G:\Documents and Settings\ | .123 | Application/ | N/A | N/A | Not |
| | John Doe\MyDocuments\Projects\ | | x-pdf | | | Relevant |
| | Red Projects\Memos.zip!!Memo.123 | | | | | |
| F₅ | G:\Documents and Settings\ | .12 2003.rev.1 | Application/ | N/A | N/A | Relevant & |
| | John Doe\MyDocuments\Projects\ | | msword | | | Privileged |
| | Blue Projects\Memo Sept.12 2003.rev.1 | | | | | |
| F′₅ | H:\Litigation E-mail\John Doe\ | .12 2003.rev.1 | Application/ | N/A | N/A | Relevant & |
| | doej2.nsf!!2F07DF673EC9!!Memo Sept.12 | | msword | | | Privileged |
| | 2003.rev.1 | | | | | |
| F″₅ | G:\Documents and Settings\John Doe\ | .12 2003.rev.1 | Application/ | N/A | N/A | Relevant & |
| | MyDocuments\Projects\Red Projects\ | | msword | | | Privileged |
| | Memos.zip!!Memo Sept.12 2003.rev.1 | | | | | |
| F₇ | G:\Documents and Settings\ | [NULL] | Application/ | N/A | N/A | Not |
| | John Doe\My Documents\Projects\ | | ms-excel | | | Relevant |
| | Red Projects\John | | | | | |
| F′₇ | G:\Documents and Settings\ | [NULL] | Application/ | N/A | N/A | Not |
| | John Doe\MyDocuments\Projects\ | | ms-excel | | | Relevant |
| | Red Projects\Memos.zip!!John | | | | | |
| F₉ | G:\Documents and Settings\ | .ctl | Text/plain | N/A | N/A | Relevant |
| | John Doe\My Documents\Programs\ | | | | | |
| | program.ctl | | | | | |
| F₁₂ | H:\Litigation E-mail\ | [NULL] | Text/plain | “On” | N/A | Not |
| | John Doe\doej2\nsf!!244BFE5B9C92 | | | | | Relevant |
| F₁₃ | H:\Litigation E-mail\ | [NULL] | Text/plain | “Off” | See FIG. | Not |
| | John Doe\doej2\nsf!!2F07DF673EC9 | | | | 4M, “File | Relevant |
| | | | | | Pointer 1” | |
| F₁₄ | H:\Litigation E-mail\ | [NULL] | Text/plain | “Off” | See FIG. | Not |
| | John Doe\doej2\nsf!!401F645E221A | | | | 4N, “File | Relevant |
| | | | | | Pointer 1” | |
| F₁₅ | G:\Documents and Settings\ | .zip | application/ | N/A | See FIG. | Not |
| | John Doe\My Documents\Projects\Red | | zip | | 4O, “File | Relevant |
| | Projects\Memos.zip | | | | Pointer 1”, | |
| | | | | | “File Pointer 2”, | |
| | | | | | “File Pointer 3” | |

The electronic files in the that are unable to be opened by the operating agent A are relegated to the second subset S₂. Thus, in the context of the example being developed, the electronic files F₁ (and its copy F′₁ in FIG. 4A), F₃ (FIG. 4C), F₄ (FIG. 4D), F₆ (FIG. 4F), F₈ (FIG. 4H), F₁₀ (FIG. 4J) and F₁₁ (FIG. 4K) are contained within the second subset S₂. Information regarding each electronic file in the second subset S₂ is entered into a “log file” L (or another suitable document tracking database) created by the operating agent A and stored in the memory M_{L}. Again, since the files grouped into the second subset S₂ physically remain in the servers G and H, they are depicted in FIG. 1 in dashed-line outline form, indicating that only information about these files is stored in memory M_{L}.

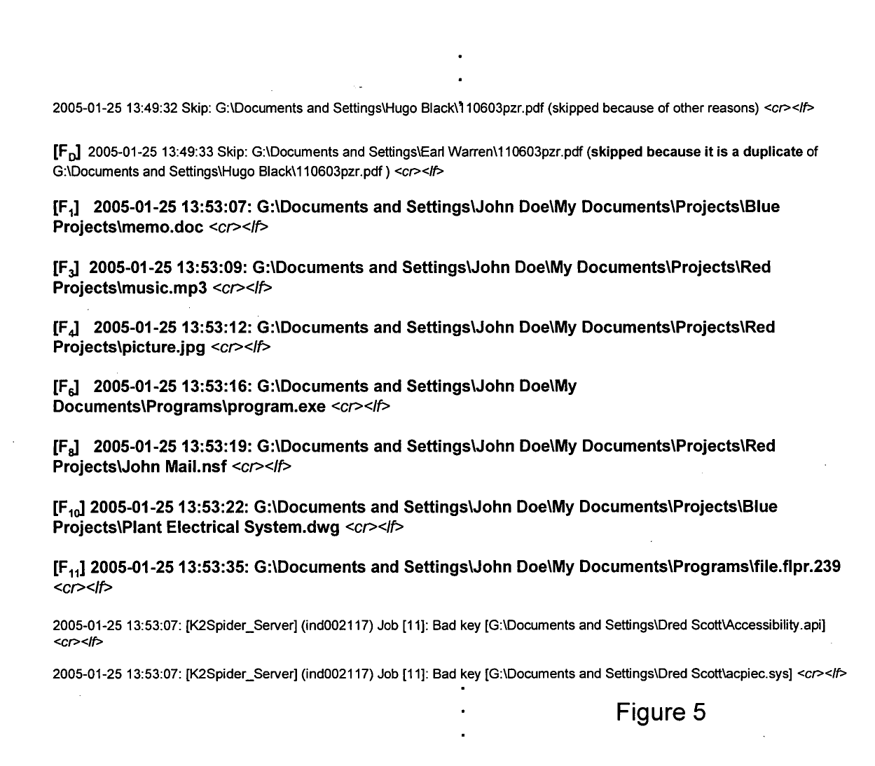

FIG. 5 illustrates an excerpt of the log file L. The log file L is a single file that includes an entry for each file in the second subset S₂. The entries for each file are separated from each other by a carriage return “<cr><lf>”.

As seen from FIG. 5 a typical entry in the log file L for a given electronic file includes the file locator R native attribute of that file, in toto. The file locator R itself includes native attributes such as file name and one (or more) file extension(s). Thus, at least one native attribute for each electronic file in the second subset S₂ is contained within an entry in the log file L for an electronic file. An entry may also include an error notation indicating the problem(s) encountered by the operating agent with the electronic file.

The operating agent A also determines whether any file is a duplicate of a file already indexed. The operating agent A generates a hash code for each electronic file that is able to be opened thereby. The hash code of a given electronic file is compared with the hash code of each of the other electronic files opened by the operating agent. If the given file is determined to be a duplicate it is assigned to the second subset S₂ and an appropriate entry included within the log file L. An example of an entry denoting a duplicate file F_{D} in is indicated in FIG. 5. This entry indicates that the file F_{D} in the custody of “Earl Warren” is a duplicate of a file named “110603” in the custody of “Hugo Black”.

Note that that copies of electronic files that are designated by a file pointer (F′₁, F′₂, F′₅, F″₅, and F′₇) are not considered duplicates by the operating agent A.

In one aspect the present invention is directed to a computer-implemented method for identifying selected electronic files from a set of electronic files that contains at least one mail file, to a computer-readable medium containing instructions for controlling a computing system implement the method, and to a computer-readable medium containing a data structure produced by the implementation of the method.

In another aspect the present invention is directed to a computer-implemented method for identifying and mapping compound electronic files to a file class, to a computer-readable medium containing instructions for controlling a computing system implement the method, and to a computer-readable medium containing a data structure produced by the implementation of the method.

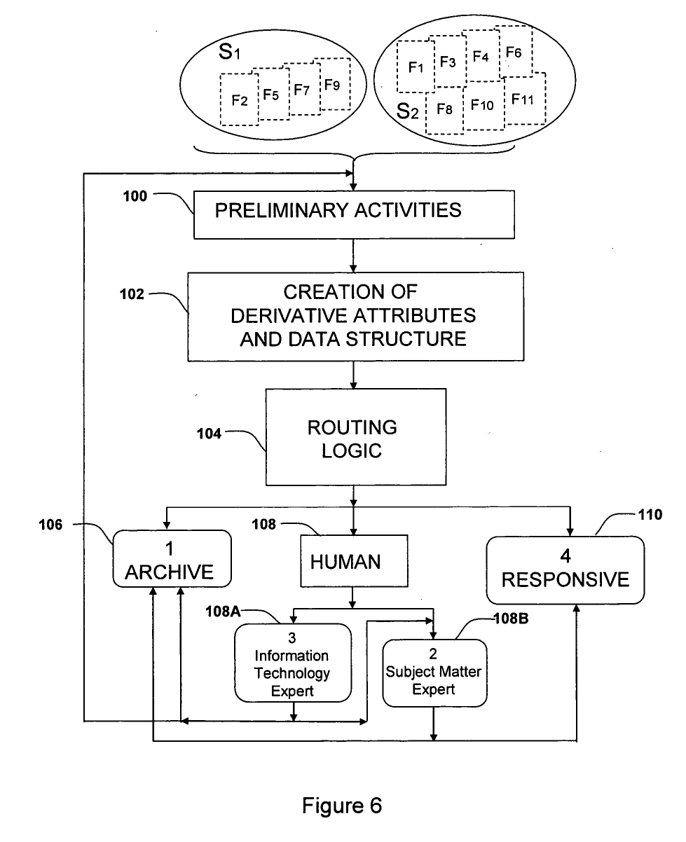

FIGS. 6A and 6B show an overall block diagram of the program of the present invention 10 as implemented by the processor 14 (FIG. 1). See also, “Code Listing 6” in the Appendix. In general, FIG. 6A shows the treatment of individual electronic files and FIG. 6B shows the aggregation of individual electronic files into file groups and the treatment of such groups. With reference to FIG. 6A, summarizing the operation of the operating agent explained above, the operating agent A performs various preliminary steps, as generally by the block 100. These preliminary activities include subdividing the set of electronic files into the first and second subsets S₁ and S₂. For the files it is able to open using one of the available gateways and document filter (i.e., the files in the first subset S₁) the operating agent A creates an index I that includes the various native attributes present in the file. Two of the more pertinent native attributes for the present discussion, viz., file extension and MIME type, are summarized in Table 1.

The preliminary activities also include use of the operating agent A to extract all available native attributes for each electronic file. These native attributes may include the file locator R itself, as well as the various elements contained therein [such as the file name, the file paths, and the file extension(s)], the various pieces of information listed earlier about the file contained within the header H [e.g., the MIME type, privacy flag, pointer(s)]. Native attributes may further include the date of the electronic file, the title, the author, the gateway type used to open the file, and the subset S₁ or subset S₂ in which the electronic file resides.

For the files that are not able to be opened and indexed (i.e., the files in the second subset S₂) the operating agent A creates a log file L having an entry for each file (FIG. 5). Each log file entry includes the file locator native attribute, which is itself comprised of various native attributes, such as the full file path and the file extension(s) for the file.

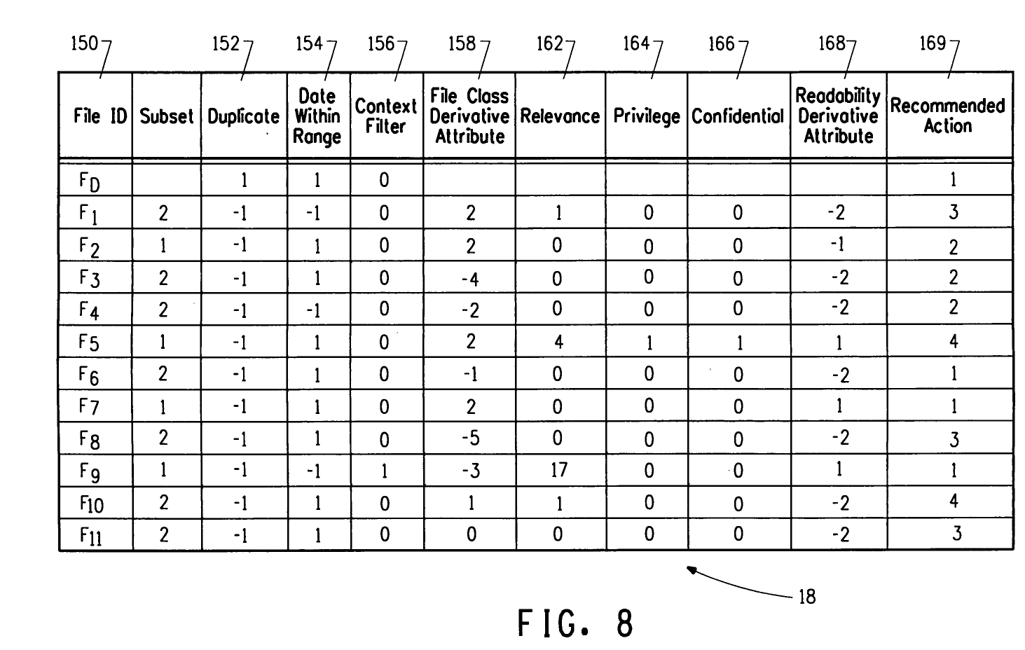

As indicated in the block 102 the first major action of the method of the present invention is to utilize the identified native attributes of the electronic files in both the first and second subsets S₁ and S₂ to generate one or more derivative attributes. These include a derivative attribute representative of the file class of the electronic file and a derivative attribute representative of the file's readability (that is, the presence of at least some predetermined number of readable characters in the accessible character strings in the file). In addition, a derivative attribute representative of the relevance of each file in the second subset S₂ is also created. As the derivative attributes for each electronic file in the first subset and second subset are created a data structure 18 (FIGS. 1 and 8) grouping the numerical value indicators for these attributes is also generated.

The state of a particular derivative attribute is indicated by a value indicator. In general, a value indicator representative of a derivative attribute may take any designed numerical, alphabetical, textual or symbolic form. In the present invention numerical value indicators are preferred because they require less memory when stored in the data structure and are amenable to easier and faster comparisons than textual string comparisons.

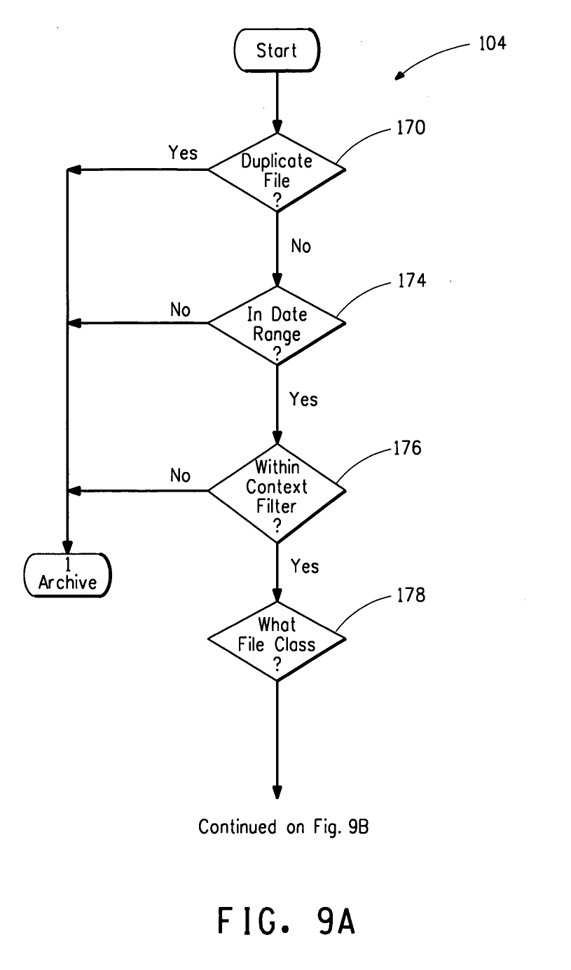

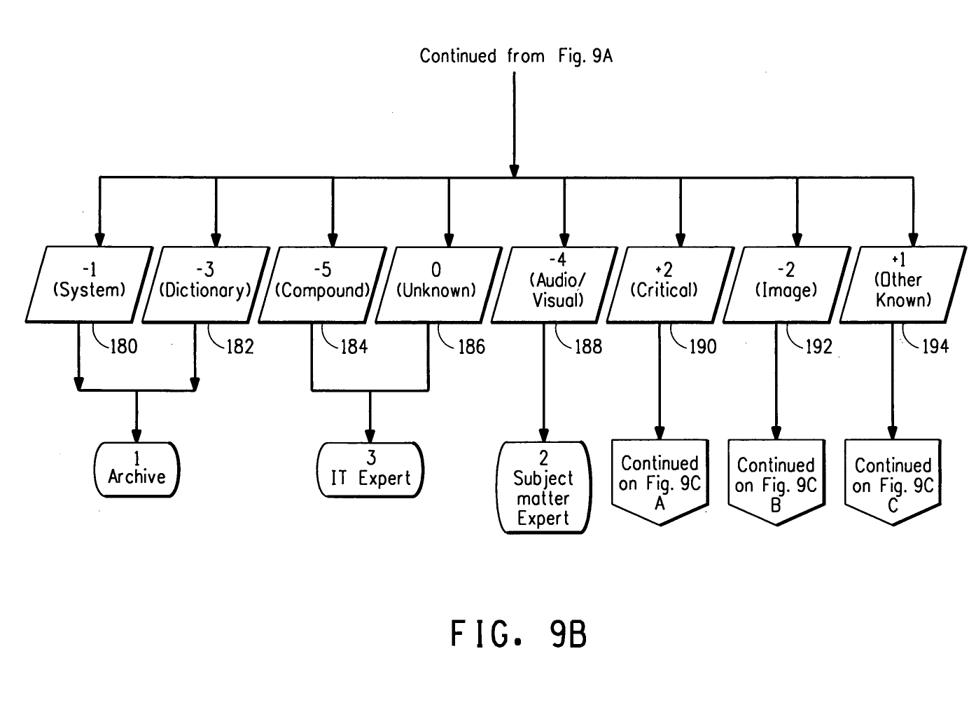

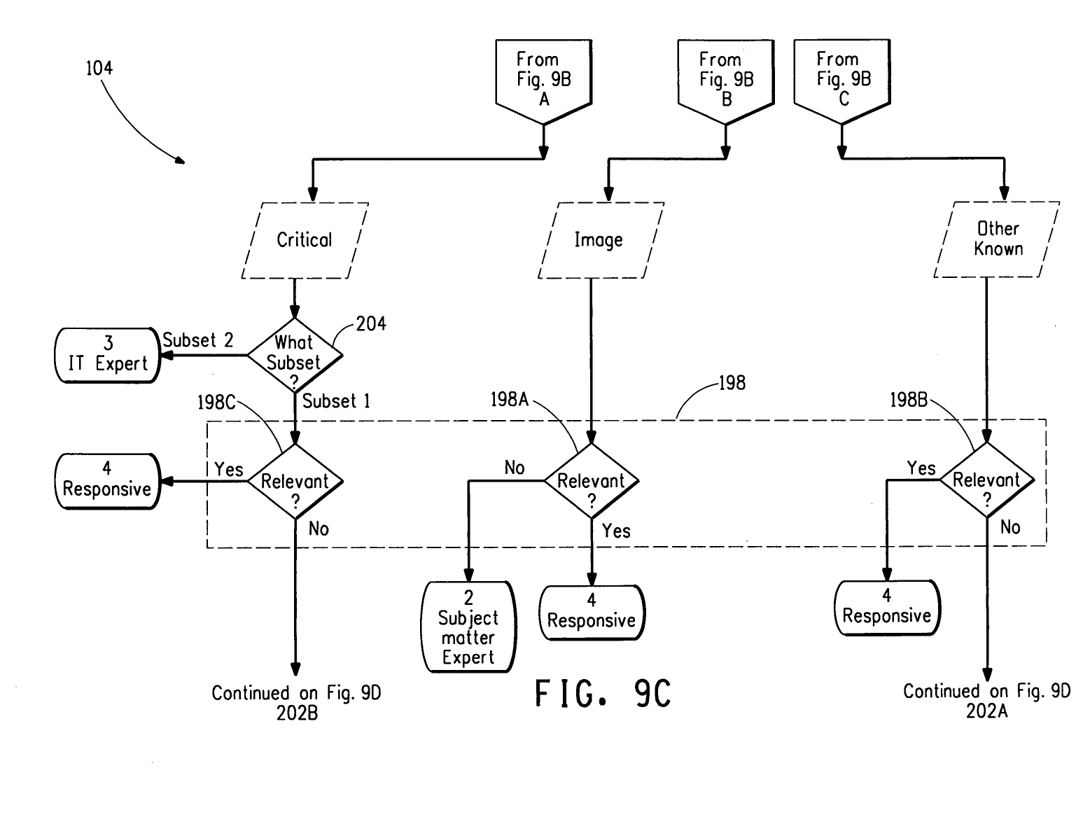

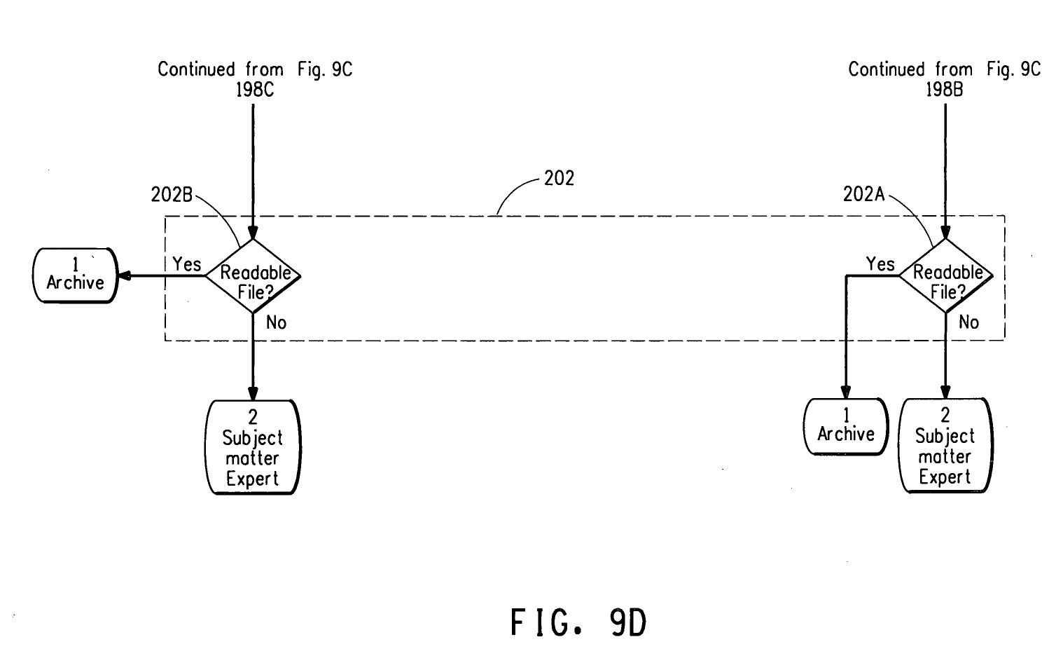

As indicated in the block 104 the method of the present invention includes routing logic (FIGS. 9A and 9B) that uses the derivative attributes contained in the data structure as the basis for identifying each electronic file in each subset for one of at least three predetermined specific recommended actions (or “destination states”). The set of recommended actions is indicated collectively by the reference character 112. The recommended actions include segregation into an archive listing as indicated at block 106, review by a human reviewer as generally indicated at block 108, or identification as fully responsive as indicated at block 110. The human review can take the form of review by an information technology expert as indicated by the block 108A, or review by a subject matter expert as indicated at the block 108B. The value representative of the recommended action is indicated in the corresponding block in FIG. 6A.

The function of the information technology expert is to open each assigned file. The file, once opened can be returned by the information technology expert to the operating agent A for the processing in accordance with blocks 100-104. The file can be referred to the subject matter expert for a subject matter determination. The file may also be sent to the archive. The subject matter expert may identify the file as responsive or marked for the archive. It should be noted that the electronic files remain physically resident in the repositories G and H, each flagged with an appropriate marker indicating the action recommended by the method of the present invention. It lies within the contemplation of the present invention that additional recommended actions could be defined.

Each recommended action is assigned a predetermined value in a hierarchical order. The value for each recommended action is indicated in the respective blocks 106, 108A, 108B and 110 in FIG. 6A by alphabetic characters. The values are in alphabetical order with the value “A” assigned to the recommended action 108A being the highest value in the hierarchy. The value “D” assigned to the recommended action 106 is the lowest value in the hierarchy. The values “B” and “C” are assigned to the recommended actions 110 and 108B, respectively.

Once each electronic file has been individually treated and classified into one of a predetermined plurality of recommended actions (FIG. 6A) the pointer native attribute is used to identify file groups and treat the identified groups.

In accordance with another aspect of the invention, as indicated in the block 115, the overall collection E of electronic files is subdivided into two different subsets S₃ and S₄. The subset S₃ identifies each electronic file that includes one or more file pointer native attributes. Such an electronic file is termed a “parent” or “parent file”. Each electronic file corresponding to each file pointer native attribute in each parent electronic file is termed a “child” or “child file” (collectively, “children”).

Once the subset of parent files is identified all remaining electronic files are relegated to the subset S₄. Thus, the subset S₄ identifies all non-parent files. Note that not every file in the subset S₄ is a child file. Many files are individually independent, with no parent-child relationship.

Each parent file and its child(ren) define a file group. Three such file groups, FG₁, FG₂, and FG₃ are illustrated in FIG. 6B. Each file group comprises one parent file and each child file corresponding thereto. Each file group is itself classified into one of the predetermined plurality of recommended actions 106, 108A, 108B and 110. This action is indicated by the block 117. As will be explained herein a file group is classified into one of the recommended actions based upon the highest hierarchical value of the recommended actions of each of the electronic files in the group. An Appendix containing a listing of program code implementing the steps in accordance with the method of the present invention is included in this description immediately preceding the claims. The code is written in SQL, HTML, Java, Verity's Java APIs and ColdFusion.

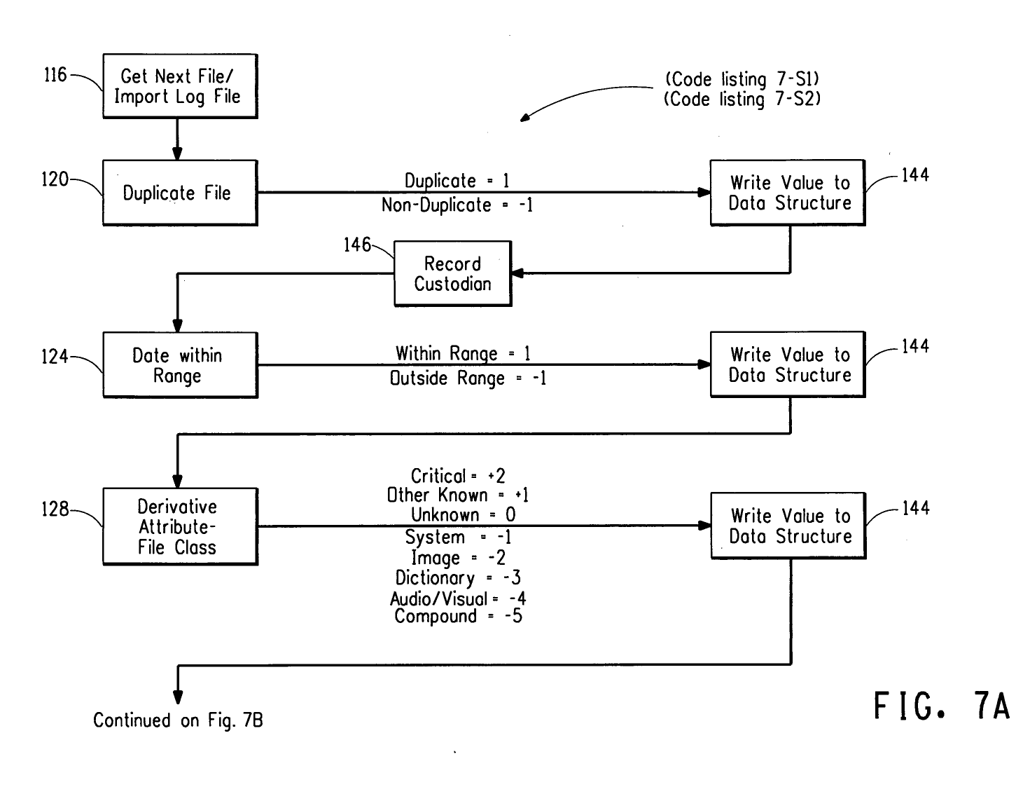

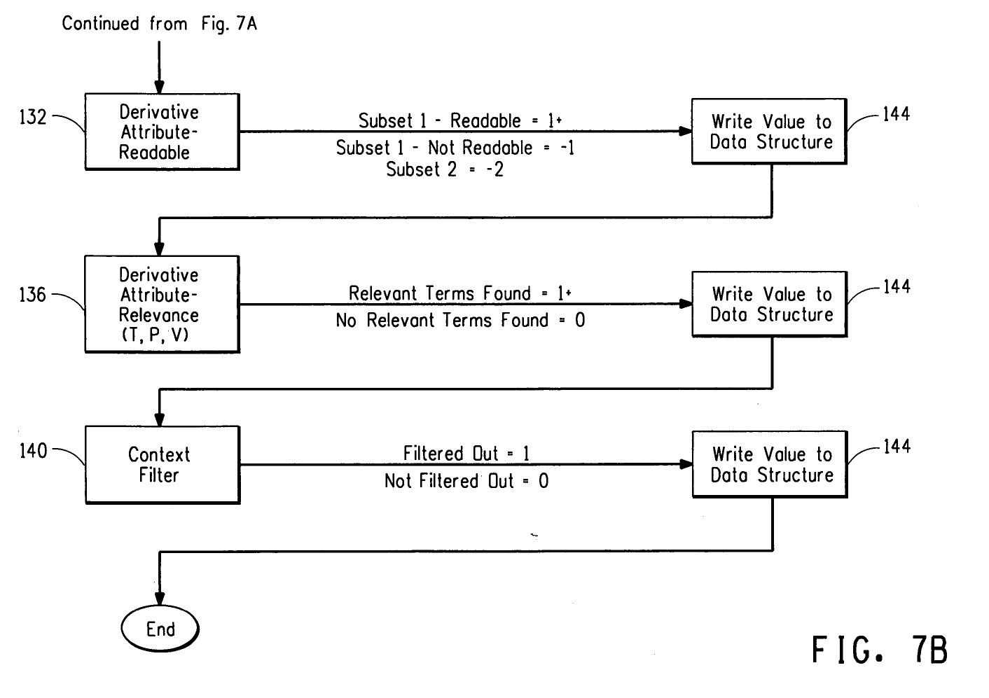

FIG. 7 is a more detailed flow diagram of the steps undertaken in the block 102 (FIG. 6A) involved in the creation of derivative attributes and the generation of the data structure 18. It should be understood that the various steps may be performed in any convenient order. See also “Code Listing 7-S1” and “Code Listing 7-S2” in the Appendix.

Each electronic file in each subset S₁ and S₂ is analyzed in turn, as generally indicated in the block 116. In the preferred implementation of the method of the present invention the operating agent A is called upon to perform various functions and derive certain conclusions, with the results being returned to the processor 14 implementing the method of the invention. However, as noted earlier, it also lies within the contemplation of the present invention that such functions may be performed by the processor 14 without direct reliance upon the operating agent A.

In the case of electronic files in the subset S₁ search instructions for locating the desired native attributes are sent in appropriate search language to the operating agent A which performs the desired comparisons and returns resulting information.

Native attributes for the electronic files in the second subset S₂ are identified by importing the entry in the log file L (FIG. 5) for each electronic file into the processor 14 implementing the program of the present invention. The log file entry is parsed to identify the file locator R native attribute of that file. Contained within the file locator native attribute R are the full file path and file extension native attributes (for files having a file locator as shown in FIG. 3A) and the full file path, the attachment file identifier and attachment file extension native attributes (for files having a file locator as shown in FIG. 3B). These attributes are used by the processor 14 to create certain derivative attributes. For other derivative attributes information with appropriate search instructions is passed to the operating agent A and the results returned.

Table 2 is a summary table listing some of the native attributes able to be isolated by parsing the log file entry for a file in the second subset. It is noted that since the MIME type is usually present in the file header of a file and since a file is relegated to the subset S₂ because it cannot be opened by the operating agent A, it follows that the log file entry for an electronic file would likely not contain the MIME type. However, it is possible that an operating agent may itself be able to extract the MIME type from the file header of a file relegated to the second subset S₂ or may include an auxiliary operating agent (not shown) to perform this function. This possibility is addressed by the inclusion in Table 2 of a column containing the MIME type.

TABLE 2
Native Attributes (Subset S₂)

| File | Full File Path | Extension(s) | MIME type |
|---|---|---|---|
| F₁ | G:\Documents and Settings\John Doe\ | .doc | application/ |
| | MyDocuments\Projects\Blue Projects\ | | msword |
| | memo.doc | | |
| F′₁ | H:\Litigation E-mail\ | .doc | application/ |
| | John Doe\doej2.nsf!! | | msword |
| | 401F645E221A!!memo.doc | | |
| F₃ | G:\Documents and Settings\John Doe\ | .mp3 | NOT AVAILABLE |
| | MyDocuments\Projects\Red Projects\music.mp3 | | |
| F₄ | G:\Documents and Settings\John Doe\ | .jpg | image/jpeg |
| | MyDocuments\Projects\Red Projects\ | | |
| | picture.jpg | | |
| F₆ | G:\Documents and Settings\John Doe\ | .exe | application/ |
| | MyDocuments\Programs\program.exe | | octet-stream |
| F₈ | G:\Documents and Settings\John Doe\ | .nsf | NOT |
| | MyDocuments\Projects\Red Projects\ | | AVAILABLE |
| | John Mail.nsf | | |
| F₁₀ | G:\Documents and Settings\John Doe\ | .dwg | image/ |
| | MyDocuments\Projects\Blue Projects\ | | ind.dwg |
| | Plant Electrical System.dwg | | |
| F₁₁ | G:\Documents and Settings\John Doe\ | .flpr.239 | NOT |
| | MyDocuments\Programs\file.flpr.239 | | AVAILABLE |

The manner in which the various derivative attributes for an electronic file in each subset S₁ and S₂ are created is next discussed.

Duplicate The operating agent A, as part of the preliminary operations, determines using a hash code analysis whether a given electronic file is a duplicate of another electronic file. If so, that file is relegated to the subset S₂ and an appropriate indication is made in the log file entry for that file (see file F_{D}, FIG. 5). Accordingly, as indicated by the block 120, if in parsing a log file entry it is determined that a file is a duplicate a predetermined value indicator (e.g., “1”) is assigned to that file. A different value indicator (e.g., “−1”) is assigned to that file if it has not been previously identified as a duplicate.

In general, before the data structure 18 is populated with the numeric value indicators for each derivative attribute all entries are reset to a predetermined initial (or, default) value (e.g., “0”). Accordingly, it is preferred that, in most cases, each numeric value indicator assigned by the present invention is different from the default value.

Date As indicated in functional block 124 the operating agent A may be used to determine whether a given electronic file in the first and second subsets falls within a predetermined defined target date range. Assuming that a native attribute containing a date indicator is available either in the index I for a file in the first subset S₁ or in the log file L for a file in the second subset S₂, that date indicator is arithmetically compared by the operating agent A to a target date range. If the date of the file falls within the predetermined defined target date range a predetermined value indicator (e.g., “1”) is assigned to that electronic file; otherwise, a different value indicator (e.g., “−1”) is assigned.

File Class Derivative Attribute The derivative attribute representative of the file class of the electronic file is generated in functional block 128. For each electronic file in the first and second subsets S₁ and S₂ a derivative attribute having a value representative of a file class of the electronic file is created. The value of this file class derivative attribute provides an indication of the software application used to create the electronic file and/or the type of software application intended to open the electronic file.

Each electronic file in the subsets S₁ and S₂ is mapped uniquely to one of nine distinct file classes. These file classes (and their corresponding numerical value indicator) are:
I. Critical (2)
II. Image (−2)
III. Audio/Visual (−4)
IV. System (−1)
V. Dictionary (−3)
VI. Compound (−5)
   (Further Processing)
VII. Other Known (1)
VIII. Unknown (Not Mapped) (0)
IX. E-mail Message (3)

Except for the E-mail message file class each of the file classes has assigned to it one or more file extensions.

A file having as its terminal file extension the extension “.doc”, “.xls”, “.ppt”, or “.pdf” is included in the “Critical” file class. The file extension “.doc” indicates that the file is created by the Word® word processor program available from Microsoft Corporation. A file created using the Excel® spreadsheet program available from Microsoft Corporation includes the extension “.xls”. A file created using the PowerPoint® presentation graphics program available from Microsoft Corporation has the extension “.ppt”. A file created using portable document format from Adobe Acrobat® electronic document distribution and exchange creation program available from Adobe Systems Incorporated includes the extension “.pdf”.

Files within the “Image” file class typically include files having the generic graphic image format file extension “.gif” or the bit-map image file extension “.bmp”. Electronic files containing photos have the extensions “.jpg”, “.jpeg” “.jpe” are also included within this file class. A non-exhaustive list of other common file extensions included within the “Image” file class is set forth in the following List:

List 1: Image File Extensions

| | | | | |
|---|---|---|---|---|
| .ai | .clp | .dcx | .dib | .dwg |
| .eps | .fpx | .img | .jif | .mac |
| .msp | .pct | .pcx | .pic | .png |
| .ppm | .psp | .raw | .rle | .tif |
| | .tiff | | .wpg | |

Exemplary among files included in the “Audio/Visual” file class are those having as a terminal file extension the extensions “.mp3”, “.wav”, or “.au”.

Commonly used extensions for files in the “System” file class include the extension “.exe” for executable files and the extension “.dll” for directory files. A non-exhaustive list of other common file extensions for this file class is set forth in the following List:

List 2: System File Extensions

| | | | | |
|---|---|---|---|---|
| .aba | .acq | .bat | .bi$ | .bin |
| .cab | .cfm | .cls | .clx | .co$ |
| .com | .ctx | .daz | .dbd | .ddd |
| .did | .dsk | .ex? | .ex_{—} | .exa |
| .exz | .gid | .grd | .hdr | .hl$ |
| .hlp | .hiz | .li$ | .lib | .lic |
| .lnk | .ncf | .ob? | .ocx | .pkg |
| .qdat | .ql$ | .tda | .tlb | .ttf |

Exemplary of a file assigned to the “Dictionary” file class is a file having the terminal file extension “.ctl”.

Files in the “Compound” file class are files which, when examined by a human with the correct reader, contain a plurality of individual records which need to be handled with independent further processing. Some examples of file extensions typically encountered include in this file class include files with the terminal extension “.nsf”, “.mbx” or “.pst”. These extensions are all associated with electronic mail files. The file extension “.nsf” is used with the Lotuse® Notes® email program available from IBM Corporation. The extension “.mbx” is included with messages using the Eudora® email program available from Qualcomm Incorporated. The extension “.pst” is included with the Outlook® communications program available from Microsoft Corporation. Other files included within the “Compound” file class include database files with the extension “.mdb” and a compressed file with an extension “.zip”.

As examples of file extensions typically encountered in the “Other Known” file class are the following: files having the extension “.afm” created using Abassis Finance Management Software from SmartMedia Informatica; files having the extension “.mso” created using the Microsoft FrontPage Web site creation and management program available from Microsoft Corporation; hypertext extensions “.htm” or “.html”; print extension “.prn”; and comma-separated values extension “.csv”.

An example of a file extension included within the “Unknown (Not Mapped)” file class includes the file extension [Null].

The generation of the file class derivative attribute for a collection E that includes at least one mail file is governed by a mail mapping rule (“Mail Message Mapping Rule”) and two electronic file mapping rules (“Electronic File Mapping Rule I”) and (“Electronic File Mapping Rule II”), respectively. The Mail Message Mapping Rules is indicated in the tables by the reference character “M”. The particular Electronic File Mapping Rule is indicated in the tables by the reference characters “I” and “II”, respectively.

For a set of electronic files that contains at least one mail file the operating agent A and a mail server gateway (e.g., the gateway W₂) are used to open the mail file. The file locator R for each of the plurality of electronic files in the opened mail file is parsed to determine the number of mail message markers (e.g., “!!”) found therein.

In accordance with the Mail Message Mapping Rule the electronic file is mapped to a predetermined file class based upon the number of mail message markers in the file locator. For example, in the preferred implementation of the present invention, the presence of only a single mail message marker in the file locator R serves as the basis for assignment of that file to a predetermined file class (here, file class IX—E-mail Message). The file class derivative attribute has a value of +3.

If two or more mail message markers are present in the file locator R the two Electronic File Mapping Rules are used to define the file class derivative attribute. In accordance with the Electronic File Mapping Rule I”, if for a given electronic file the terminal file extension native attribute is identified and the MIME type native attribute is not available, the value of the file class derivative attribute representative of that electronic file is determined by mapping that terminal file extension to its corresponding file class.

The application of this Electronic File Mapping Rule I is made clear from examples derived from Table 2. Recall that, in the typical instance, the MIME type for each electronic file in the second subset S₂ is not available. Accordingly, the file class for each of these electronic files is determined the terminal file extension.

In the case of electronic file F₁ (FIG. 4A) the file extension “.doc” maps this file to File Class I-Critical and is accorded a numerical value indicator of “2”.

For electronic file F₃ (FIG. 4C) the file extension “.mp3” mandates a mapping to File Class III-Audio/Visual. A numerical value indicator of “−4” is accorded to this file.

The file extension “.jpg” for electronic file F₄ (FIG. 4D) maps that file to File Class II-Image, with a numerical value indicator of “−2”.

The “.exe” extension for file F₆ (FIG. 4F) results in a mapping for that file to File Class IV-System. A numerical value indicator of “−1” is assigned.

The file F₈ (FIG. 4H), having the extension “.nsf”, results in a File Class VI-Compound (Further Processing). The numerical value indicator assigned is “−5”.

Electronic file F₁₀ (FIG. 4J) has the file extension “.dwg”. This extension results in that file being mapped to File Class VII—Other Known and the assignment of a numerical value indicator of (1). The “0.239” terminal file extension for file F₁₁ (FIG. 4K) causes that electronic file to be mapped to File ClassVIII-Unknown. The numerical value indicator assigned has the value “0”.

The Electronic File Mapping Rule II is applied in instances in which both the terminal file extension and the MIME type native attributes are identified for an electronic file. In this situation a combination of these attributes is used to create the value of the file class derivative attribute and numerical value indicator.

In general, if the MIME type of a given file is an approved MIME type, then the mapping is determined by the MIME type. However, if that MIME type is not an approved MIME type the mapping is determined by the terminal file extension. Basically, if there is a mismatch between the MIME type and the file extension for a given file, the MIME type governs the mapping so long as the MIME type is an approved (trustworthy) MIME type. Otherwise, the file extension governs the mapping.

Whether a MIME type is an approved MIME type can be determined by testing the MIME type of a given file against a reference set of MIME types. The reference set may be configured in two ways: viz., to contain a list of approved MIME types; or to contain a list of unapproved MIME types. If the reference set is a list of approved MIME types, and if the MIME type under test falls within that list, then the MIME type is an approved MIME type. Alternatively, if the reference set is a list of un-approved MIME types, and if the MIME type under test falls within that list, then the MIME type is would be un-approved MIME type.

The MIME types included within a reference set of approved MIME types can be selected in any desired manner. The set can include any combination of the general MIME type categories and/or selected subcategories. The selection of the MIME types within the predetermined set of approved MIME types is usually determined empirically.

Generally speaking, the MIME types included within this set have proven to be trustworthy indicia of the application program creating a given file.

Accordingly, with this empirical baseline a representative reference of set of approved MIME types could be defined to include the following collection of general categories and subcategories:

List 3: Representative Set of Approved MIME Types

| | |
|---|---|
| [a] image/gif | [b] image/x-ms-bmp |
| [c] image/x-photo-cd | |
| [d] audio/basic | [e] audio/x-wav |
| [f] x-music/x-midi | [g] video/x-msvideo |
| [h] application/msword | |
| [i] application/vnd.ms-excel | |
| [j] application/x-msexcel | |
| [k] application/x-excel | |
| [l] application/x-dos_ms_excel | |
| [m] application/vnd.ms-powerpoint | |
| [n] application/mspowerpoint | |
| [o] image/vnd.dwg | |
| [p] application/x-dvi | |
| [q] application/zip | [r] application/mac- |
| | binhex40 |

A reference set configured to include unapproved MIME types would contain MIME types that are typically assigned as a default, such as the following “text” subcategories:

| | |
|---|---|
| text/html | text/plain |
| text/richtext | text/x-sextet |
| text/enriched | text/sgml |
| text/x-speech | text/css |
| text/tab-separated-values | |

Each of the MIME types in the set of approved MIME types maps to a predetermined file class and associated numerical value indicator, as shown in the following Table:

TABLE 3

| MIME Type | File Class | Value |
|---|---|---|
| [a]-[c] | II. Image | (−2) |
| [d]-[g] | III. Audio/Visual | (−4) |
| [i]-[n] | I. Critical | (2) |
| [o]-[p] | VII. Other Known | (1) |
| [q]-[r] | VI. Compound | (−5) |

The electronic files in the first subset S₁ can be used to exemplify the application of the Electronic File Mapping Rule II. It can be seen from Table 1 that the identified MIME type for each of the files F₂ (FIG. 4B), F₅ (FIG. 4E) and F₇ (FIG. 4F) falls within the set of approved MIME types. Thus, the MIME type native attribute predominates over the terminal extension native attribute in determining the file class derivative attribute. Under this rule the files F₂, F₅ and F₇ all map to File Class I-Critical.

However, in the case of electronic file F₉, since the MIME type (“text/plain”) is not within the set of approved MIME types, the terminal extension “.ctl” determines the file class derivative attribute. The file is mapped by Mapping Rule II to File Class V-Dictionary.

The File Class derivative attribute for each of the electronic files in the collection E are summarized in Table 4.

TABLE 4
File Class Derivative Attributes

| | | | Derivative | File | |
|---|---|---|---|---|---|
| | Extension | | Attribute | Class | Mapping |
| File | (s) | MIME type | File Class | Value | Rule |
| F₁ | .doc | Application/ | File Class I | 2 | I |
| | | msword | Critical | | |
| F′₁ | .doc | Application/ | File Class I | 2 | I |
| | | msword | Critical | | |
| F₂ | .123 | Application/ | File Class I | 2 | II |
| | | x-pdf | Critical | | |
| F₃ | .mp3 | NOT | File Class III | −4 | I |
| | | AVAILABLE | Audio/Visual | | |
| F₄ | .jpg | Image/jpeg | File Class II | −2 | I |
| | | | Image | | |
| F₅ | .jpg | Application/ | File Class I | 2 | II |
| | | msword | Critical | | |
| F′₅ | .jpg | Application/ | File Class I | 2 | II |
| | | msword | Critical | | |
| F″₅ | .jpg | Application/ | File Class I | 2 | II |
| | | msword | Critical | | |
| F₆ | .exe | Application/ | File Class IV | −1 | I |
| | | octet-stream | System | | |
| F₇ | [NULL] | Application/ | File Class I | 2 | II |
| | | ms-excel | Critical | | |
| F′₇ | [NULL] | Application/ | File Class I | 2 | II |
| | | ms-excel | Critical | | |
| F₈ | .nsf | NOT | File Class VI | −5 | I |
| | | AVAILABLE | Compound | | |
| F₉ | .ctl | NOT | File Class V | −3 | II |
| | | AVAILABLE | Dictionary | | |
| F₁₀ | .dwg | Image/ | File Class VII | 1 | I |
| | | Vnd.dwg | Other Known | | |
| F₁₁ | .flpr.239 | NOT | File Class VIII | 0 | I |
| | | AVAILABLE | Unknown | | |
| F₁₂ | [NULL] | Text/plain | File Class IX | 3 | M |
| | | | E-mail Message | | |
| F₁₃ | [NULL] | Text/plain | File Class IX | 3 | M |
| | | | E-mail Message | | |
| F₁₄ | [NULL] | Text/plain | File Class IX | 3 | M |
| | | | E-mail Message | | |
| F₁₅ | .zip | Application/ | File Class VI | −5 | I |
| | | zip | Compound | | |

In accordance with this invention, if the collection E of electronic files does not include a mail file, then the Mail Message Mapping Rule is not invoked but is skipped. In that instance the appropriate Electronic File Mapping Rule I or Electronic File Mapping Rule II are directly applied.

The creation of the derivative attributes in the blocks 132, 136 and 140 is implemented using the operating agent A.

Readability As indicated in block 132, for each electronic file in the first and second subsets a derivative attribute having a value representative of the amount of electronically readable text in the electronic file is created.

If an electronic file is in the first subset, the value of the readability derivative attribute is based upon the presence of at least some predetermined threshold number of readable characters in the accessible character strings. Typically, the predetermined number is on the order of twenty characters. If a file contains more than the predetermined number of readable characters it is deemed “readable” and assigned a predetermined value indicator (e.g., “1”). Otherwise, it is deemed “not readable” and assigned a different value indicator (e.g., “−1”) is assigned. For electronic files in the second subset the value of the readability derivative attribute is based upon the presence of that file in the second subset. It is assumed that by the mere fact of inclusion in the second subset the file is “not readable” and the value indicator (e.g., “−2”) is assigned.

The readability derivative attribute for each of the electronic files in the collection E are summarized in Table 5.

TABLE 5

| | Readability |
|---|---|
| Electronic | Derivative |
| Files | Attribute |
| F₁ | −2 |
| F′₁ | −2 |
| F₂ | −1 |
| F₃ | −2 |
| F₄ | −2 |
| F₅ | 1 |
| F′₅ | 1 |
| F″₅ | 1 |
| F₆ | −2 |
| F₇ | 1 |
| F′₇ | 1 |
| F₈ | −2 |
| F₉ | 1 |
| F₁₀ | −2 |
| F₁₁ | −2 |
| F₁₂ | −2 |
| F₁₃ | 1 |
| F₁₄ | 1 |
| F₁₅ | −2 |

Relevance In accordance with another aspect of the method of the present invention the native attribute(s) for each of the files in the second subset S₂ as identified in the log file L is(are) used to generate another derivative attribute representative of the file's relevance to a predetermined issue. This action is indicated in the block 136.

The derivative attribute has a value representative of the file's relevance based upon the presence or absence of at least one of the target character strings in the identified native attribute.

To determine this derivative attribute the full file locator native attribute in the log file is tested against target character strings T, P and V.

A positive value of the relevance derivative attribute for each file in the second subset is determined by the number of character strings in the file that fall within the appropriate set of target character strings. If the file is not relevant, the value of the derivative attribute is the default value of “0”.

The full file locator native attribute is also tested against the privilege and confidentiality target character lists.

The relevance, privilege and confidential derivative attributes for each of the electronic files in the collection E is summarized in Table 6. The electronic files in the first subset S₁ are included in Table 6 for completeness and are denoted by the “*” symbol.

TABLE 6

| | Relevance | Privilege | Confidential |
|---|---|---|---|
| Electronic | Derivative | Derivative | Derivative |
| Files | Attribute | Attribute | Attribute |
| F₁ | 1 | 0 | 0 |
| F′₁ | 1 | 0 | 0 |
| *F₂ | 0 | 0 | 0 |
| *F′₂ | 0 | 0 | 0 |
| F₃ | 0 | 0 | 0 |
| F₄ | 0 | 0 | 0 |
| *F₅ | 4 | 1 | 1 |
| *F′₅ | 4 | 1 | 1 |
| *F″₅ | 4 | 1 | 1 |
| F₆ | 0 | 0 | 0 |
| *F₇ | 0 | 0 | 0 |
| *F′₇ | 0 | 0 | 0 |
| F₈ | 0 | 0 | 0 |
| *F₉ | 17 | 0 | 0 |
| F₁₀ | 1 | 0 | 0 |
| F₁₁ | 0 | 0 | 0 |
| *F₁₂ | 0 | 0 | 0 |
| *F₁₃ | 0 | 0 | 0 |
| *F₁₄ | 0 | 0 | 0 |
| *F₁₅ | 0 | 0 | 0 |

Context Filter The operating agent A is also used to apply the context filter to electronic files in the second subset S₂. Each readable character string in the identified native attribute of each entry in the log file is tested by the context filter X (FIG. 1). This action is indicated in functional block 140. If the file is filtered-out a predetermined value indicator (“1”) is assigned to that electronic file; otherwise, a different value indicator (“0”) is assigned.

The application of the context filter to documents in the second subset is not expressly exemplified.

As seen from FIG. 7 at the output of each of the blocks 120, 124, 128, 132, 136 and 140, the value of the derivative attribute created for each file is written into a two-dimensional data structure 18. This action is indicated by the blocks 144. A representation of the relevant portion of the data structure 18 so populated is illustrated in FIG. 8.

Since no date range is defined herein, it is noted that the date values included in column 154 of the data structure for files in the first subset are hypothetical. However, with regard to files in the second subset since the preferred operating agent A identified earlier does not extract the date native attribute from those files, the value of the derived attribute is automatically set to the value “1” (a file cannot be excluded based on the absence of a date).

Each derivative attribute is assigned one respective dimension (e.g., a column) in the two-dimensional data structure. A column is also reserved for a suitable file identifier (e.g., file locator). Taken along the other dimension of the data structure (e.g., a row) the data structure groups the value of each derivative attribute created for an electronic file identified by the file identifier into a record. In FIG. 8 the derivative attributes for the files F₁ through F₁₅ here under discussion, as well as an illustrative entry for the F_{D} (FIG. 5), are shown.

As seen from FIG. 8, the column 150 contains the file identifier for each file. The columns 152, 154, 156 are respectively dedicated to the values of the derivative attributes representative of the duplicate, date and context filter. The values assigned for the file class derivative attribute are collected in the column 158. The values assigned for the readability derivative attribute are contained in the column 168.

The derivative attributes for relevance, privilege and confidentiality are contained in the columns 162-166, respectively.

In the case of a duplicate file, the custodian of any duplicate files is recorded, as indicated at functional block 146.

A detailed flow diagram of the routing logic 104 (FIG. 6A) is shown in FIGS. 9A and 9B. See also, “Code Listing 9” in the Appendix. In general, once the file class derivative attribute is determined and the data structure 18 (FIG. 8) populated, the derivative attributes are used to assign each electronic file in the first and second subsets to a selected state representative of the specific recommended actions shown in FIG. 6A, viz., Archive (block 106); review by a human reviewer (blocks 108A or 108B); or identification as fully Responsive (block 110).

A value representative of the recommended action for an individual electronic file is recorded in column 169A of the data structure 18. If the recommended action for a file is Archive a value “1” is recorded in column 169A. Human Review by an Subject Matter Expert is assigned the value “2”, while review by an Information Technologist is assigned the value “3”. Fully Responsive is assigned the value “4”.

The routing logic is sequentially applied to each file in the collection (including the copies F′₁, F′₂, F′₅, F″₅, and F′₇). This classifies each electronic file in the set into one of the predetermined plurality of recommended actions. The values for the derivative attributes for each file in the collection (i.e., a row of the data structure 18) are used by the routing logic to make particular decisions about that file.

As indicated by the blocks 170, 174, 176 and 177 certain preliminary pruning operations are first performed.

In the block 170 the electronic file being routed is tested to determine whether it is a duplicate of another file. For example, in the case of the file F_{D} (FIG. 5) the presence of the particular value indicating that this file is a duplicate (i.e., the value in column 152 of the data structure for the row having this file identifier) results in this file being routed to the archival repository.

The derivative attributes representing whether a file falls within the predetermined date range and within the context filter (i.e., the values in columns 154 and 156 of the data structure for the row having the given file identifier) are respectively tested functional blocks 174 and 176. If a given file is outside the date range or the context filter it is routed to the archival repository.

As shown in functional block 177, an E-mail message that has an asserted (“ON”) privacy flag is routed to an information technologist expert who is able to unlock the message.

The value of the file class derivative attribute for a given file is tested in the block 178. Depending upon the value of the numerical indicator in column 158 of the data structure for the row having the given file identifier, the file is routed to one of nine data blocks 180-195.

Files in System (File Class IV) or Dictionary (File Class V) are routed directly to the archive.

Files in Compound (File Class VI) or Unknown (File Class VIII) are routed directly for human review by an information technology expert. Files in Audio/Visual (File Class III) are sent for human review by a subject matter expert.

For electronic files in Image (File Class II) or Other Known (File Class VII) the value of the numerical indicator for the derivative attribute in column 162 of the data structure for the row having these file identifiers is tested for relevance in the blocks 198A, 198B. Depending upon the outcome of the test (in the block 198A) an Image file is assigned for human review by a subject matter expert or directly to Responsive. For a file in the class “Other Known” the outcome of the test in the block 198B is routed either to Responsive or subjected to a readability test in the block 202A. In the block 202A the value indicator in column 168 of the data structure for the row having this file identifier determines whether the file is routed to the Archive or for Human Review by a subject matter expert.

If an electronic file from subset S₂ is routed to Critical (File Class I) it is directed for review by an information technology expert as indicated by the block 204. A file from subset S₁ is that is routed to Critical (File Class I) is tested for relevance and readability in the blocks 198C and 202B. Depending upon the results of these tests the file is directed to Responsive (from the block 198C) or to the Archive or for Human Review by a subject matter expert (from the block 202B).

As with an electronic file routed to Critical (File Class I), an electronic file routed to E-mail Message (File Class IX) has its subset checked as indicated by the block 203. An electronic file from the subset S₂ is directed for review by an information technology expert. An electronic file from subset S₁ is tested for relevance in the block 198D. Depending upon the results of this test the electronic file is directed to Responsive (from the block 198D) or to the Archive.

Once each electronic file has been individually treated and classified into one of a predetermined plurality of destination states by the routing logic 104 (FIG. 6A) file groups are identified and treated (blocks 115, 117, FIG. 6B).

As alluded to earlier, in block 154 the overall collection E of electronic files is subdivided into two different subsets, viz, subset S₃ (parents) and subset S₄ (non-parents). The pointer native attribute is used to identify parents. All electronic files that have an entry in the “File Pointer” column (Table 1) are identified as parents and assigned to the subset S₃.

Once an electronic file is identified as a parent, file groups (E.G., FG₁, FG₂, FG₃) are defined. This action occurs in block 117 (FIG. 6B). The pointer native attribute(s) contained in each parent is(are) used to identify the child(ren). A parent and the child(ren) corresponding thereto comprise a file group (either FG₁, FG₂, or FG₃; FIG. 6B)

For example, since the pointer in the electronic F₁₃ (FIG. 4M) identifies the electronic file F′₅, the file group FG₁ includes the parent electronic file F₁₃ and its child electronic file F′₅. Similarly, the pointer in the electronic F₁₄ (FIG. 4N) identifies the electronic file F′₁. Thus, the file group FG₂ includes the parent electronic file F₁₄ and its child electronic file F′₁. In the case of parent electronic file F₁₅, three electronic file pointers are included therein. The file group FG₃ thus includes the parent electronic file F₁₅ and its three children, electronic files F′₂, F′₇ and F″₅.

Once identified, each file group is classified into one of the predetermined plurality of recommended actions. To effect this classification the recommended action for each electronic file in a file group is examined. The classification of a file group into its group recommended action is based upon the highest-ordered recommended action of any of the electronic files in the group.

In the case of file group FG₁ the parent electronic file F₁₃ has a recommended action of Archive corresponding to value D in the hierarchy. The child file F′₅ has a recommended action Responsive with a value B in the hierarchy. Since the hierarchical value of the child is greater that that of the parent, the file group is assigned a group recommended action of Responsive (hierarchical value B).

Similarly, for file group FG₂ the parent electronic file F₁₄ also has a recommended action Archive (hierarchy value D) while the child electronic file F′₁ has a recommended action Information Technologist (hierarchy value A). Since the hierarchical value A is greater than hierarchical value D the file group is assigned a group recommended action of Information Technologist (hierarchy value A).

For the file group FG₃ the highest individual hierarchical value for any electronic file in the group is Responsive (electronic file F″₅, hierarchy value B). Thus, the overall file group is assigned a group recommended action of that recommended action.

In this way each file group FG₁, FG₂ and FG₃ is assigned to only one of the four recommended actions 106, 108A, 108B, 110.

The group recommended action for each file group is indicated in column 169B of the data structure 18 (FIG. 8).

As may be appreciated from the foregoing the present invention provides a method, program and data structure that identifies electronic files from a set of files in a manner that is cheaper, easier, more trustworthy and more accurate.

In the instance where the set of electronic files includes a mail file or other type of compound file all electronic files contained in the compound file are properly processed and tracked.

Use of the present invention is believed cheaper and easier because it minimizes the number of electronic files that require human intervention by eliminating duplicates (while retaining significant custodial information) and eliminating system and dictionary files (e.g., file F₉) which may be otherwise erroneously identified as relevant.

The present invention is believed to provide a more trustworthy and more accurate result because it processes files which may be critical to the issues at hand but which heretofore are relegated to the log file and not considered. For instance, both password locked file F₁ and drawing file F₁₀ are relevant to the issues of the example developed herein, but these important files would previously be discarded. The present invention avoids the problem (exemplified by the file F₂) of falsely identifying a file as not relevant because no readable text is found when, in fact, the file is highly relevant for the issues of the lawsuit.

Those skilled in the art, having the benefit of the teachings of the present invention as hereinabove set forth, may effect modifications thereto. Such modifications are to be construed as lying within the contemplation of the present invention, as defined in the appended claims.

APPENDIX
Listing of Program Code

```
Code Listing 6:
Begin;
//Begin Figure 6A, Block 100
Crawl the set of files of interest, inserting a record for each file present
into either (a) an index, which contains all text found in each indexable
file (i.e., files in the first subset S1) or (b) a log file, containing a line for
each file which was not indexable (i.e., files in the second subset S2);
//Begin Figure 6A, Block 102
Import into the data structure the files in the first subset S1 using Code
Listing 7-S1;
Import into the data structure the files in the second subset S2 using Code
Listing 7-S2;
//End Figure 6A, Block 102
//Begin Figure 6A, Block 104
Process the data structure using Code Listing 9, thereby storing in the data
structure for each file, the value indicator representative of the
Recommended Action (Figure 8, Column 169) to which each file should
be routed (Archive 106, Subject Matter Expert 108A, Information
Technology Expert 108B, or Responsive 110);
//End Figure 6A, Block 104
//Begin Figure 6B, Blocks 115 and 117
In the data structure, identify the record corresponding to each parent file
in sequence {
  Read into memory the Recommended Action of the parent file;
  Identify all records in the data structure corresponding to child files for
the current parent. Read into memory the Recommended Action of each of
these child records;
  Determine what is the highest-ordered Recommended Action among all
files in the group;
  For each record in the group, including parent and all children, store in
the data structure this highest-ordered Recommended Action among all
files in the group;
}//Loop back and identify the next parent record
//End Figure 6B, Blocks 115 and 117
End;
Code Listing 7-S1:
Begin;
  //Begin Figure 7, Block 116
  From an index I, retrieve a result set, containing a single record for each
file in the first subset S1;
  loop through the result set, looking at one record at a time {
  retrieve the value of the field containing the file locator and store this
value in the data structure;
  from the file locator, parse out these values: file name, terminal file
extension, other file extensions; store each of these values in the data
structure;
  from the file locator, parse out the value of the name of the custodian
for this file, and store this value in the data structure;
  from the file locator, parse out other information (the availability of
which depends on the repository from which the files originated);
  retrieve the value of the field containing the last-modified date and size
in bytes of this file, and store these values in the data structure;
  Determine the gateway source from which this document was obtained.
Store the gateway source's identifier in the data structure;
  //Begin Figure 7, Block 128
  If gateway source is an email source (such as Lotus Notes) {
    determine the number of mail message markers in the file locator;
    if the number of mail message markers is less than or equal to a
predetermined number, store in the data structure a File Class value of +3
(representing parent email message)
  } else {
    retrieve the value of the field containing the MIME-type of this file;
    look up this MIME-type in an internal lookup table of approved
MIME-types: if the MIME-type corresponds to an approved type {
      store in the data structure the value indicator representative of the
File Class (Figure 8, Column 158) to which the MIME-type corresponds;
    } else {
      look up the terminal file extension in an internal lookup table
mapping file extensions to File Classes, and store in the data structure the
value indicator representative of the File Class (Figure 8, Column 158) to
which the terminal file extension corresponds;
    }
  }
  //End Figure 7, Block 128
  //Begin Figure 7, Block 132
  compare number of readable characters of text contained in the index
for this document against a predetermined threshold number of readable
characters in the accessible character strings: if the quantity of text is
greater than this threshold {
    store in the data structure a value of 1 for Readability (Figure 8,
Column 168);
  } else {
    store in the data structure a value of −1 for Readability (Figure 8,
Column 168);
  }
  //End Figure 7, Block 132
  //Begin Figure 7, Block 124
  determine if the current file's last-modified date is within the target date
range, and store in the data structure a value of 1 for the Date within
Range (Figure 8, Column 154) if it is and −1 if it is not;
  //End Figure 7, Block 124
  //Begin Figure 7, Block 136
  {
      search the file locator and all text found in the current file for all
terms of interest (using the search function operator Q and relevant
target character list T) which define a relevant file, and store the terms
found and their count in the data structure (Figure 8, Column 162);
      search the file locator and all text found in the current file for all
terms of interest (using the search function operator Q and privileged
target character list P) which define a privileged file, and store the
terms found and their count in the data structure (Figure 8, Column 164);
      search the file locator and all text found in the current document
for all terms of interest (using the search function operator Q and
confidential target character list V) which define a confidential file, and
store the terms found and their count in the data structure (Figure 8,
Column 166);
  }
  //End Figure 7, Block 136
  //Figure 7, Block 140
      search the file locator and all text found in the current document
for all terms of interest in the Context Filter X (using the search function
operator Q), store in the data structure a value of 0 for the Context Filter if
any terms are found (Figure 8, Column 156), otherwise store a value of 1;
  //End Figure 7, Block 140
}//loop back and process the next file
//End Figure 7, Block 116
End;
Code Listing 7-S2
  //Begin Figure 7, Block 116
  Convert log file containing information about files in the second subset
S2, into a block of multiple lines of text, each line representing a single
file from subset S2, and each line containing multiple fields of data
regarding that file;
  loop through this delimited string of text, looking at the information for
one line at a time {
  retrieve the value of the field containing the file locator and store this
value in the data structure;
  retrieve the value of the field containing the error information and store
this value in the data structure;
  retrieve the value of the fields containing the duplicate file information,
including whether this file is a duplicate file and if it is, the file locator
of the original file of which this is a duplicate. If such duplicate file
information is present for this file, store these text strings in the data
structure;
  from the file locator, parse out these values: file name, terminal file
extension, other file extensions; store each of these values in the data
structure;
  from the file locator, parse out the value of the name of the custodian
for this file, and store this value in the data structure;
  from the file locator, parse out other information (the availability of
which depends on the repository from which the files originated);
  using the file locator to identify the file of interest, retrieve from the file
system the last-modified date and size in bytes of this file, and store these
values in the data structure;
  //Begin Figure 7, Block 120
  if the duplicate file information is not null for this file {
    store in the data structure (Figure 8, Column 162) a value of 1 for the
Duplicate File;
    in the data structure, associate custodian name for the current file
with the record corresponding to the original file of which the current file
is a duplicate (Figure 7, Block 146);
  } else {
    store in the data structure (Figure 8, Column 162) a value of −1
for the Duplicate File;
  }
  //End Figure 7, Block 120
  Determine the gateway source from which this document was obtained.
Store the gateway source's identifier in the data structure;
  //Begin Figure 7, Block 128
  If gateway source is an email source (such as Lotus Notes) {
    determine the number of mail message markers in the file locator;
    if the number of mail message markers is less than or equal to a
predetermined number, store in the data structure a File Class value of +3
(representing parent email message)
  } else {
    retrieve the value of the field containing the MIME-type of this file;
    look up this MIME-type in an internal lookup table of approved
MIME-types: if the MIME-type corresponds to an approved type {
      store in the data structure the value indicator representative of the
File Class (Figure 8, Column 158) to which the MIME-type corresponds;
    } else {
      look up the terminal file extension in an internal lookup table
mapping file extensions to File Classes, and store in the data structure the
value indicator representative of the File Class (Figure 8, Column 158) to
which the terminal file extension corresponds;
    }
  }
  //End Figure 7, Block 128
  //Begin Figure 7, Block 132
  since this file is in subset S2, store in the data structure a −2 for
the value of Readablity (Figure 8, Column 168);
  }
  //End Figure 7, Block 132
  //Begin Figure 7, Block 124
  determine if the current file's last-modified date is within the target date
range, and store in the data structure a value of 1 for the Date within
Range (Figure 8, Column 154) if it is and −1 if it is not;
  //End Figure 7, Block 124
  //Begin Figure 7, Block 136
  {
      search the file locator for all terms of interest (using the search
function operator Q and relevant target character list T) which define a
relevant file, and store the terms found and their count in the data structure
(Figure 8, Column 162);
      search the file locator for all terms of interest (using the search
function operator Q and privileged target character list P) which define a
privileged file, and store the terms found and their count in the data
structure (Figure 8, Column 164);
      search the file locator for all terms of interest (using the search
function operator Q and confidential target character list V) which define a
confidential file, and store the terms found and their count in the data
structure (Figure 8, Column 166);
  }
  //End Figure 7, Block 136
  //Begin Figure 7, Block 140
  search the file locator for all terms of interest in the Context Filter X
(using the search function operator Q), store in the data structure a value
of 0 for the Context Filter if any terms are found (Figure 8, Column 156),
otherwise store a value of 1;
  //End Figure 7, Block 140
  }
//loop back and process the next file
//End Figure 7, Block 116
End;
Code Listing 9:
Begin;
  Retrieve the record for each file from data structure, one at a time {
  //Begin Figure 9A, Block 170
  if the indicator value representative of Duplicate File = 1 {
    set value representative of the recommended action for this record to
1, corresponding to “Archive” (Figure 6A, 106), and store in the data
structure (Figure 8, Column 169);
    loop back to next record;
  }
  //End Figure 9A, Block 170
  //Begin Figure 9A, Block 174
  if the indicator value representative of Date within Range < 0 {
    set value representative of the recommended action for this record to
1, corresponding to “Archive” (Figure 6A, 106), and store in the data
structure (Figure 8, Column 169);
    loop back to next record;
  }
  //End Figure 9A, Block 174
  //Begin Figure 9A, Block 176
  if the indicator value representative of Context Filter = 1 {
    set value representative of the recommended action for this record to
1, corresponding to “Archive” (Figure 6A, 106), and store in the data
structure (Figure 8, Column 169);
    loop back to next record;
  }
  //End Figure 9A, Block 176
  //Begin Figure 9A, Block 177
  if the privacy flag is set {
    set value representative of the recommended action for this record to
3, corresponding to “Information Technology Expert” (Figure 6A, 108A),
and store in the data structure (Figure 8, Column 169);
    loop back to next record;
  }
  //End Figure 9A, Block 177
  //Begin Figure 9A, Block 178
  //Begin Figure 9A, Blocks 180 & 182
  if the indicator value representative of File Class corresponds to
“System” or “Dictionary” file class {
    set value representative of the recommended action for this record to
1, corresponding to “Archive” (Figure 6A, 106), and store in the data
structure (Figure 8, Column 169);
    loop back to next record;
  }
  //End Figure 9A, Blocks 180 & 182
  //Begin Figure 9A, Blocks 184 & 186
  if the indicator value representative of File Class corresponds to
“Compound” or Unknown” file class {
    set value representative of the recommended action for this record to 3,
corresponding to “Information Technology Expert” (Figure 6A, 108A),
and store in the data structure (Figure 8, Column 169);
    loop back to next record;
  }
  //End Figure 9A, Blocks 184 & 186
  //Begin Figure 9A, Block 188
  if the indicator value representative of File Class corresponds to “Audio
Visual” file class {
    set value representative of the recommended action for this record to 2,
corresponding to “Subject Matter Expert” (Figure 6A, 108B), and store in
the data structure (Figure 8, Column 169);
    loop back to next record;
  }
  //End Figure 9A, Block 188
  //Begin Figure 9A, Block 190
  if the indicator value representative of File Class corresponds to
“Critical” file class {
    //Figure 9B, Block 204
    if file is in the second subset of files S2 {
    set value representative of the recommended action for this record to
3, corresponding to “Information Technology Expert” (Figure 6A, 108A),
and store in the data structure (Figure 8, Column 169);
      loop back to next record;
    } else {
      //Figure 9B, Block 198C
      if the indicator value representative of Relevance > 0 {
      set value representative of the recommended action for this record
to 4, corresponding to “Responsive” (Figure 6A, 110), and store in the
data structure (Figure 8, Column 169);
        loop back to next record;
      } else {
        //Figure 9B, Block 202B
        if the indicator value representative of Readability > 0 {
        set value representative of the recommended action for this
record to 1, corresponding to “Archive” (Figure 6A, 106), and store in the
data structure (Figure 8, Column 169);
          loop back to next record;
        } else {
        set value representative of the recommended action for this
record to 2, corresponding to “Subject Matter Expert” (Figure 6A, 108B),
and store in the data structure (Figure 8, Column 169);
          loop back to next record;
        }
      }
    }
  }
  //End Figure 9A, Block 190
  //Begin Figure 9A, Block 192
  if the indicator value representative of File Class corresponds to
“Image” file class {
    //Figure 9B, Block 198A
    if the indicator value representative of Relevance > 0 {
      set value representative of the recommended action for this record
to 4, corresponding to “Responsive” (Figure 6A, 110), and store in the
data structure (Figure 8, Column 169);
      loop back to next record;
    } else {
        set value representative of the recommended action for this
record to 2, corresponding to “Subject Matter Expert” (Figure 6A, 108B),
and store in the data structure (Figure 8, Column 169);
      loop back to next record;
    }
  }
  //End Figure 9A, Block 192
  //Begin Figure 9A, Block 194
  if the indicator value representative of File Class corresponds to “Other
Known” file class {
    //Figure 9B, Block 198B
    if the indicator value representative of Relevance > 0 {
      set value representative of the recommended action for this record
to 4, corresponding to “Responsive” (Figure 6A, 110), and store in the
data structure (Figure 8, Column 169);
      loop back to next record;
    } else {
      //Figure 9B, Block 202A
      if the indicator value representative of Readability > 0 {
        set value representative of the recommended action for this
record to 1, corresponding to “Archive” (Figure 6A, 106), and store in the
data structure (Figure 8, Column 169);
        loop back to next record;
      } else {
        set value representative of the recommended action for this
record to 2, corresponding to “Subject Matter Expert” (Figure 6A, 108B),
and store in the data structure (Figure 8, Column 169);
        loop back to next record;
      }
    }
  }
  //End Figure 9A, Block 194
  //Begin Figure 9A, Block 195
  if the indicator value representative of File Class corresponds to “Email
Message” file class {
    //Figure 9B, Block 203
    if file is in the second subset of files S2 {
    set value representative of the recommended action for this record to
2, corresponding to “Information Technologist” (Figure 6A, 108A), and
store in the data structure (Figure 8, Column 169);
      loop back to next record;
    } else {
      //Figure 9B, Block 198D
      if the indicator value representative of Relevance > 0 {
        set value representative of the recommended action for this
record to 4, corresponding to “Responsive” (Figure 6A, 110), and store in
the data structure (Figure 8, Column 169);
        loop back to next record;
      } else {
        set value representative of the recommended action for this
record to 1, corresponding to “Archive” (Figure 6A, 106), and store in the
data structure (Figure 8, Column 169);
      }
    }
  }
  //End Figure 9A, Block 195
  //End Figure 9A, Block 178
}//Loop back and process next file's record
End;
```

What is claimed is:

1. A computer-implemented method for identifying electronic files from a set of electronic files,
the set of electronic files containing at least one mail file, the mail file itself including a plurality of electronic files,
each electronic file in the mail file including a document locator, each document locator having one or more mail message markers therein,
the method including the steps of:
(i) using an operating agent and a mail server gateway, opening the mail file;
(ii) for each of the plurality of electronic files in the opened mail file,
creating a derivative attribute representative of the file class of that electronic file,
the creation of each file class derivative attribute itself comprising the steps of:
(a) determining the number of mail message markers in the file locator of that file; and
(b) mapping that file to a file class if the file locator includes a predetermined number of mail message markers.

2. The computer-implemented method of claim 1 wherein, for each file whose file locator does not include the predetermined number of mail message markers,
the method further including the steps of:
using the operating agent,
identifying a first subset of electronic files having each electronic file that is able to be opened by the operating agent,
identifying a second subset having each electronic file in the remainder of the set of electronic files,
for each electronic file in the first and second subsets, identifying at least one native attribute contained in the electronic file, the at least one identified native attribute including one or more file extensions;
wherein the method further comprises:
(a) for each electronic file in the first and second subsets, creating a derivative attribute having a value representative of the file class for the electronic file,
the creation of each file class derivative attribute itself comprising the steps of:
(i) identifying a terminal file extension for that electronic file; and
(ii) mapping that terminal file extension to a file class.

3. The computer-implemented method of claim 1, wherein, for each file whose file locator does not include the predetermined number of mail message markers,
the method further including the steps of:
using an operating agent,
identifying a first subset of electronic files having each electronic file that is able to be opened by the operating agent,
identifying a second subset having each electronic file in the remainder of the set of electronic files,
for each electronic file in the first subset, identifying at least a first and a second native attribute contained in the electronic file,
the first identified native attribute including one or more file extensions,
the second identified native attribute being MIME type; and wherein,
for each electronic file in the second subset, identifying at least one native attribute contained in the electronic file, the at least one native attribute including one or more file extensions; and
wherein the method further comprises:
(a) for each electronic file in the first subset, creating a derivative attribute having a value representative of the file class of the electronic file,
the creation of each file class derivative attribute itself comprising the steps of:
(i) identifying a terminal file extension for that electronic file in the first subset; and
(ii) mapping a combination of the identified terminal file extension and the MIME type to a file class,
wherein the mapping is determined by the MIME type if the MIME type falls within a predetermined set of approved MIME types, and
wherein the mapping is determined by the terminal file extension if that MIME type falls outside of the predetermined set of approved MIME types; and
(b) for each electronic file in the second subset, creating a derivative attribute having a value representative of the file class of the electronic file,
the creation of each file class derivative attribute itself comprising the steps of:
(i) identifying a terminal file extension for that electronic file in the second subset; and
(ii) mapping that terminal file extension to a file class.

4. The computer-implemented method of claim 1, wherein, for each file whose file locator does not include the predetermined number of mail message markers,
the method further including the steps of:
using an operating agent,
identifying a first subset of electronic files having each electronic file that is able to be opened by the operating agent,
identifying a second subset having each electronic file in the remainder of the set of electronic files,
for each electronic file in the first and second subsets, identifying at least a first and a second native attribute contained in the electronic file,
the first identified native attribute including one or more file extensions,
the second identified native attribute being MIME type;
wherein the method further comprises:
(a) for each electronic file in the first and second subsets, creating a derivative attribute having a value representative of the file class of the electronic file,
the creation of each file class derivative attribute itself comprising the steps of:
(i) identifying a terminal file extension for the electronic file; and
(ii) mapping a combination of the identified terminal file extension and the MIME type to a file class,
wherein the mapping is determined by the MIME type if the MIME type falls within a predetermined set of approved MIME types, and
wherein the mapping is determined by the terminal file extension if that MIME type falls outside of the predetermined set of approved MIME types.

5. The computer-implemented method of claim 1, wherein, for each file whose file locator does not include the predetermined number of mail message markers,
the method further including the steps of:
using a first operating agent,
identifying a first subset of electronic files having each electronic file that is able to be opened by the operating agent,
identifying a second subset having each electronic file in the remainder of the set of electronic files,
for each electronic file in the first subset, identifying at least a first and a second native attribute contained in the electronic file,
the first identified native attribute including one or more file extensions,
the second identified native attribute being MIME type,
for each electronic file in the second subset, identifying at least a first native attribute contained in the electronic file, the at least one native attribute identified by the operating agent including one or more file extensions; and
wherein, using another operating agent,
for each electronic file in the second subset, identifying a second native attribute contained in the electronic file, the second identified native attribute being MIME type;
wherein the method further comprises:
(a) for each electronic file in the first and second subsets, creating a derivative attribute having a value representative of the file class of the electronic file,
the creation of each file class derivative attribute itself comprising the steps of:
(i) identifying a terminal file extension for the electronic file; and
(ii) mapping a combination of the identified terminal file extension and the MIME type to a file class,
wherein the mapping is determined by the MIME type if the MIME type falls within a predetermined set of approved MIME types, and
wherein the mapping is determined by the terminal file extension if that MIME type falls outside of the predetermined set of approved MIME types.

6. The method of claim 2 wherein the method includes the further step of:
using the operating agent
for each electronic file in the second subset, identifying at least one additional native attribute contained in the electronic file; and
defining a set of one or more target character
strings indicative of a predetermined topic,
wherein the method further comprises:
(b) for each electronic file in the second subset, creating a derivative attribute having a value representative of the file's relevance to the predetermined topic,
the derivative attribute being based upon the presence or absence of at least one of the target character strings in the additional identified native attribute for each electronic file in the second subset.

7. The method of claim 3 wherein the method includes the further step of:
using the operating agent
for each electronic file in the second subset, identifying at least one additional native attribute contained in the electronic file; and
defining a set of one or more target character
strings indicative of a predetermined topic,
wherein the method further comprises:
(c) for each electronic file in the second subset, creating a derivative attribute having a value representative of the file's relevance to the predetermined topic,
the derivative attribute being based upon the presence or absence of at least one of the target character strings in the additional identified native attribute for each electronic file in the second subset.

8. The method of claim 4 wherein the method includes the further step of:
using the operating agent
for each electronic file in the second subset, identifying at least one additional native attribute contained in the electronic file; and
defining a set of one or more target character
strings indicative of a predetermined topic,
wherein the method further comprises:
(b) for each electronic file in the second subset, creating a derivative attribute having a value representative of the file's relevance to the predetermined topic,
the derivative attribute being based upon the presence or absence of at least one of the target character strings in the additional identified native attribute for each electronic file in the second subset.

9. The method of claim 5 wherein the method includes the further step of:
using one of the operating agents
for each electronic file in the second subset, identifying at least one additional native attribute contained in the electronic file; and
defining a set of one or more target character
strings indicative of a predetermined topic,
wherein the method further comprises:
(b) for each electronic file in the second subset, creating a derivative attribute having a value representative of the file's relevance to the predetermined topic,
the derivative attribute being based upon the presence or absence of at least one of the target character strings in the additional identified native attribute for each electronic file in the second subset.

10. The method of claim 2 wherein, using the operating agent,
from each electronic file in the first subset, creating an index containing every accessible character string in the electronic file,
wherein the method further comprises:
(b) for each electronic file in the first and second subsets, creating a derivative attribute having a value representative of the amount of electronically readable text in the electronic file,
for electronic files in the first subset, the value of the derivative attribute being based upon the presence of at least some predetermined threshold number of accessible character strings; and
for electronic files in the second subset, the value of the derivative attribute being based upon the presence of that file in the second subset.

11. The method of claim 3 wherein, using the operating agent,
from each electronic file in the first subset, creating an index containing every accessible character string used in the electronic file,
wherein the method further comprises:
(c) for each electronic file in the first and second subsets, creating a derivative attribute having a value representative of the amount of electronically readable text in the electronic file,
for electronic files in the first subset, the value of the derivative attribute being based upon the presence of at least some predetermined threshold number of accessible character strings; and
for electronic files in the second subset, the value of the derivative attribute being based upon the presence of that file in the second subset.

12. The method of claim 4 wherein, using the operating agent,
from each electronic file in the first subset, creating an index containing every accessible character string used in the electronic file,
wherein the method further comprises:
(b) for each electronic file in the first and second subsets, creating a derivative attribute having a value representative of the amount of electronically readable text in the electronic file,
for electronic files in the first subset, the value of the derivative attribute being based upon the presence of at least some predetermined threshold number of accessible character strings; and
for electronic files in the second subset, the value of the derivative attribute being based upon the presence of that file in the second subset.

13. The method of claim 5 wherein, using one of the operating agents,
from each electronic file in the first subset, creating an index containing every accessible character string used in the electronic file,
wherein the method further comprises:
(b) for each electronic file in the first and second subsets, creating a derivative attribute having a value representative of the amount of electronically readable text in the electronic file,
for electronic files in the first subset, the value of the derivative attribute being based upon the presence of at least some predetermined threshold number of accessible character strings; and
for electronic files in the second subset, the value of the derivative attribute being based upon the presence of that file in the second subset.

14. The method of claim 2 wherein the method further comprises the step of:
(b) storing in a data structure the value of the derivative attribute representative of the file class of each electronic file.

15. The method of claim 3 wherein the method further comprises the step of:
(c) storing in a data structure the value of the derivative attribute representative of the file class of each electronic file.

16. The method of claim 4 wherein the method further comprises the step of:
(b) storing in a data structure the value of the derivative attribute representative of the file class of each electronic file.

17. The method of claim 5 wherein the method further comprises the step of:
(b) storing in a data structure the value of the derivative attribute representative of the file class of each electronic file.

18. The method of claim 2 wherein the method further comprises the step of:
(b) based upon the values of the derivative attribute representative of the file class of a electronic file, assigning that electronic file to a selected one of at least three predetermined states.

19. The method of claim 3 wherein the method further comprises the step of:
(c) based upon the values of the derivative attribute representative of the file class of a electronic file, assigning that electronic file to a selected one of at least three predetermined states.

20. The method of claim 4 wherein the method further comprises the step of:
(b) based upon the values of the derivative attribute representative of the file class of a electronic file, assigning that electronic file to a selected one of at least three predetermined states.

21. The method of claim 5 wherein the method further based upon the values of the derivative attribute representative of the file class of a electronic file, assigning that electronic file to a selected one of at least three predetermined states.

22. The method of claim 6 wherein the method further comprises the step of:
(c) based upon the values of the derivative attribute representative of the file class and relevance, assigning each electronic file to a selected one of at least three predetermined states.

23. The method of claim 7 wherein the method further comprises the step of:
(d) based upon the values of the derivative attribute representative of the file class and relevance, assigning each electronic file to a selected one of at least three predetermined states.

24. The method of claim 8 wherein the method further comprises the step of:
(c) based upon the values of the derivative attribute representative of the file class and relevance, assigning each electronic file to a selected one of at least three predetermined states.

25. The method of claim 9 wherein the method further comprises the step of:
(c) based upon the values of the derivative attribute representative of the file class and the amount of electronically readable text, assigning each electronic file to a selected one of at least three predetermined states.

26. The method of claim 10 wherein the method further comprises the step of:
(c) based upon the values of the derivative attribute representative of the file class and the amount of electronically readable text, assigning each electronic file to a selected one of at least three predetermined states.

27. The method of claim 11 wherein the method further comprises the step of:
(d) based upon the values of the derivative attribute representative of the file class and the amount of electronically readable text, assigning each electronic file to a selected one of at least three predetermined states.

28. The method of claim 12 wherein the method further comprises the step of:
(c) based upon the values of the derivative attribute representative of the file class and the amount of electronically readable text, assigning each electronic file to a selected one of at least three predetermined states.

29. The method of claim 13 wherein the method further comprises the step of:
(c) based upon the values of the derivative attribute representative of the file class and the amount of electronically readable text, assigning each electronic file to a selected one of at least three predetermined states.

30. The method of claim 18 wherein the method further comprises:
(c) storing in a data structure the selected one of at least three predetermined recommended actions.

31. The method of claim 19 wherein the method further comprises:
(d) storing in a data structure the selected one of at least three predetermined recommended actions.

32. The method of claim 20 wherein the method further comprises:
(c) storing in a data structure the selected one of at least three predetermined recommended actions.

33. The method of claim 21 wherein the method further comprises:
(c) storing in a data structure the selected one of at least three predetermined recommended actions.

34. The method of claim 22 wherein the method further comprises:
(d) storing in a data structure the selected one of at least three predetermined recommended actions.

35. The method of claim 23 wherein the method further comprises:
(e) storing in a data structure the selected one of at least three predetermined recommended actions.

36. The method of claim 24 wherein the method further comprises:
(d) storing in a data structure the selected one of at least three predetermined recommended actions.

37. The method of claim 25 wherein the method further comprises:
(d) storing in a data structure the selected one of at least three predetermined recommended actions.

38. The method of claim 26 wherein the method further comprises:
(d) storing in a data structure the selected one of at least three predetermined recommended actions.

39. The method of claim 27 wherein the method further comprises:
(e) storing in a data structure the selected one of at least three predetermined recommended actions.

40. The method of claim 28 wherein the method further comprises:
(d) storing in a data structure the selected one of at least three predetermined recommended actions.

41. The method of claim 29 wherein the method further comprises:
(d) storing in a data structure the selected one of at least three predetermined recommended actions.

42. A computer readable medium having instructions for controlling a computing system to perform a method for identifying electronic files from a set of electronic files, the set of electronic files containing at least one mail file, the mail file itself including a plurality of electronic files,
each electronic file in the mail file including a document locator, each document locator having one or more mail message markers therein,
the method including the steps of:
(i) using an operating agent and a mail server gateway, opening the mail file;
(ii) for each of the plurality of electronic files in the opened mail file,
creating a derivative attribute representative of the file class of that electronic file,
the creation of each file class derivative attribute itself comprising the steps of:
(a) determining the number of mail message markers in the file locator of that file; and
(b) mapping that file to a file class if the file locator includes a predetermined number of mail message markers.

43. The computer readable medium of claim 42, wherein, for each file whose file locator does not include the predetermined number of mail message markers,
the method further includes the steps of:
using an operating agent,
identifying a first subset of electronic files having each electronic file that is able to be opened by the operating agent,
identifying a second subset having each electronic file in the remainder of the set of electronic files,
for each electronic file in the first and second subsets, identifying at least one native attribute contained in the electronic file, the at least one identified native attribute including one or more file extensions;
wherein the method further comprises:
(a) for each electronic file in the first and second subsets, creating a derivative attribute having a value representative of the file class for the electronic file,
the creation of each file class derivative attribute itself comprising the steps of:
(i) identifying a terminal file extension for that electronic file; and
(ii) mapping that terminal file extension to a file class.

44. The computer readable medium of claim 42, wherein, for each file whose file locator does not include the predetermined number of mail message markers,
the method further includes the steps of:
using an operating agent,
identifying a first subset of electronic files having each electronic file that is able to be opened by the operating agent,
identifying a second subset having each electronic file in the remainder of the set of electronic files,
for each electronic file in the first subset, identifying at least a first and a second native attribute contained in the electronic file,
the first identified native attribute including one or more file extensions,
the second identified native attribute being MIME type; and wherein,
for each electronic file in the second subset, identifying at least one native attribute contained in the electronic file, the at least one native attribute including one or more file extensions; and
wherein the method further comprises:
(a) for each electronic file in the first subset, creating a derivative attribute having a value representative of the file class of the electronic file,
the creation of each file class derivative attribute itself comprising the steps of:
(i) identifying a terminal file extension for that electronic file in the first subset; and
(ii) mapping a combination of the identified terminal file extension and the MIME type to a file class,
wherein the mapping is determined by the MIME type if the MIME type falls within a predetermined set of approved MIME types, and
wherein the mapping is determined by the terminal file extension if that MIME type falls outside of the predetermined set of approved MIME types; and
(b) for each electronic file in the second subset, creating a derivative attribute having a value representative of the file class of the electronic file,
the creation of each file class derivative attribute itself comprising the steps of:
(i) identifying a terminal file extension for that electronic file in the second subset; and
(ii) mapping that terminal file extension to a file class.

45. The computer readable medium of claim 42, wherein, for each file whose file locator does not include the predetermined number of mail message markers,
the method further includes the steps of:
using an operating agent,
identifying a first subset of electronic files having each electronic file that is able to be opened by the operating agent,
identifying a second subset having each electronic file in the remainder of the set of electronic files,
for each electronic file in the first and second subsets, identifying at least a first and a second native attribute contained in the electronic file,
the first identified native attribute including one or more file extensions,
the second identified native attribute being MIME type;
wherein the method further comprises:
(a) for each electronic file in the first and second subsets, creating a derivative attribute having a value representative of the file class of the electronic file,
the creation of each file class derivative attribute itself comprising the steps of:
(i) identifying a terminal file extension for the electronic file; and
(ii) mapping a combination of the identified terminal file extension and the MIME type to a file class,
wherein the mapping is determined by the MIME type if the MIME type falls within a predetermined set of approved MIME types, and
wherein the mapping is determined by the terminal file extension if that MIME type falls outside of the predetermined set of approved MIME types.

46. The computer readable medium of claim 42, wherein, for each file whose file locator does not include the predetermined number of mail message markers,
the method further includes the steps of:
using a first operating agent,
identifying a first subset of electronic files having each electronic file that is able to be opened by the operating agent,
identifying a second subset having each electronic file in the remainder of the set of electronic files,
for each electronic file in the first subset, identifying at least a first and a second native attribute contained in the electronic file,
the first identified native attribute including one or more file extensions,
the second identified native attribute being MIME type,
for each electronic file in the second subset, identifying at least a first native attribute contained in the electronic file, the at least one native attribute identified by the operating agent including one or more file extensions; and
wherein, using another operating agent,
for each electronic file in the second subset, identifying a second native attribute contained in the electronic file, the second identified native attribute being MIME type;
wherein the method further comprises:
(a) for each electronic file in the first and second subsets, creating a derivative attribute having a value representative of the file class of the electronic file,
the creation of each file class derivative attribute itself comprising the steps of:
(i) identifying a terminal file extension for the electronic file; and
(ii) mapping a combination of the identified terminal file extension and the MIME type to a file class,
wherein the mapping is determined by the MIME type if the MIME type falls within a predetermined set of approved MIME types, and
wherein the mapping is determined by the terminal file extension if that MIME type falls outside of the predetermined set of approved MIME types.

47. A computer-readable medium containing a data structure generated by a computer-implemented method for identifying selected electronic files from a set of electronic files, the set of electronic files containing at least one mail file, the mail file itself including a plurality of electronic files,
each electronic file in the mail file including a document locator, each document locator having one or more mail message markers therein,
the method including the step of creating a derivative attribute having a value representative of the mapping of each electronic file in the mail file to a file class, each mapping being determining in accordance with the number of mail message markers in the file locator of each file;
the data structure grouping the derivative attribute representative of the mapping of each file with an identifier for that electronic file.
